(19) United States
(12) Patent Application Publication
(10) Pub. No.: US 2017/0026683 A1
(43) Pub. Date: Jan. 26, 2017

(54) APPARATUS AND METHOD FOR PROVIDING A USER CUSTOMIZED AND/OR PERSONAL TELEVISION AND/OR ENTERTAINMENT ACCOUNT

(71) Applicant: RAYMOND ANTHONY JOAO, YONKERS, NY (US)

(72) Inventor: RAYMOND ANTHONY JOAO, YONKERS, NY (US)

(21) Appl. No.: 15/287,436

(22) Filed: Oct. 6, 2016

Related U.S. Application Data
(63) Continuation of application No. 14/161,726, filed on Jan. 23, 2014.
(60) Provisional application No. 61/850,602, filed on Feb. 19, 2013.

(51) Int. Cl. H04N 21/414; H04N 21/2668; H04N 21/45; H04N 21/258

(52) U.S. Cl. CPC H04N 21/41407; H04N 21/25891; H04N 21/2668; H04N 21/4532

(57) ABSTRACT

An apparatus, including a communication device of a user which receives entertainment content provided pursuant to the user's personal entertainment account which is administered by a central processing computer and includes information regarding user pre-selected entertainment content, which communication device transmits a request to receive entertainment content from among user pre-selected content and roaming entertainment content identified by the central processing computer based upon location or position of the communication device or based on a time zone within which the communication device is located, and an entertainment device or a television. The communication device is connected to or linked with the entertainment device or television and transmits the entertainment content requested to the entertainment device or television. Information regarding use of the personal entertainment account or the use of the roaming entertainment content is stored in the central processing computer.

### RELATED APPLICATIONS

This application is a continuation application of U.S. patent application Ser. No. 14/161,726, filed Jan. 23, 2014, and entitled “APPARATUS AND METHOD FOR PROVIDING A USER CUSTOMIZED AND/OR PERSONAL TELEVISION AND/OR ENTERTAINMENT ACCOUNT”, the subject matter and teachings of which are hereby incorporated by reference herein in their entirety. U.S. patent application Ser. No. 14/161,726 claims the benefit of the priority of U.S. Provisional Patent Application Ser. No. 61/850,602, filed Feb. 19, 2013, and entitled “APPARATUS AND METHOD FOR PROVIDING A USER CUSTOMIZED AND/OR PERSONAL TELEVISION AND/OR ENTERTAINMENT ACCOUNT”, the subject matter and teachings of which are hereby incorporated by reference herein in their entirety.

### FIELD OF THE INVENTION

The present invention pertains to an apparatus and method for providing a user customized and/or personal television account and/or personal entertainment account and, in particular, the present invention pertains to an apparatus and method for providing a user customized personal television account and/or personal entertainment account which is customizable by the user and/or which can be accessed via a user communication device or a user's personal communication device.

### BACKGROUND OF THE INVENTION

Millions of individuals enjoy watching television each day in order to receive information regarding news and current events or simply as a form of entertainment. Many individuals also enjoy keeping current with local news and events as well as watching certain television stations, programs, or programming. Cable television and satellite television subscription services provide an excellent choice for receiving in-home television, media, and entertainment, but these subscription services are typically offered in or with a basis programming package and other extra cost channel packages. Further, these conventional cable television and satellite television subscription services are typically sold to households and are provided via a household account.

There are a number of disadvantages of these conventional cable television and satellite television subscription services. These disadvantages include the facts that these conventional cable television and satellite television subscription services are typically provided in an account fashion with channel packages, which once configured, offer little or no flexibility thereto, they fail to provide individual users of a household to customize their own channel selection, they can only be accessed at home via a so-called cable box or satellite television box, and/or they lack access portability when users or subscribers are travelling or otherwise away from home. The present invention provides an apparatus and method which overcomes these shortfalls by providing an apparatus and method for providing a user customized personal television and/or entertainment account.

### SUMMARY OF THE INVENTION

The present invention pertains to an apparatus and method, for providing a user customized and/or personal television account and/or personal entertainment account and, in particular, the present invention pertains to an apparatus and method for providing a user customized personal television account and/or personal entertainment account which is customizable by the user and/or which can be accessed via a user communication device or a user's personal communication device, which overcomes the shortcomings of the prior art.

The apparatus of the present invention can include a central processing computer which can perform any of the processing routines and functionality described herein as being performed by the apparatus and methods of the present invention. The central processing computer can be any computer, computer system, group of computers, server, server system, or group of servers which can be programmed and equipped to perform any of the herein-described functions, operations, or actions described herein as being performed by the present invention. The present invention can be utilized in connection with any number of central processing computers and the present invention can also be utilized in connection with a cloud computing system, network, and/or architecture. The central processing computer can receive and can broadcast and/or transmit any number of channels, television channels, programming channels, shows, movies, programs, broadcasts, news content, music, educational content, or any other type or kind of content, to any of the herein-described personal communication devices. Any number of central processing computers and ne utilized in the present invention.

The apparatus of the present invention can also include one or more television broadcasting/transmitting systems, each of which can be used by or which can be associated with any television station or television broadcasting company or entity which can broadcast or transmit television a show(s), program(s), broadcast(s), channels, television channels, programming channels, or any other content, one or more a cable television broadcasting/transmitting systems, each of which can be used by or which can be associated with any cable television station or cable television broadcasting company or entity which can broadcast or transmit any number of channel, television channels, programming channels, or any number of television show(s), program(s), broadcast(s), or any other content, one or more satellite television broadcasting/transmitting systems, which can be used by or which can be associated with any satellite television station or satellite television broadcasting company or entity which can broadcast or transmit any number of television channels, or any number of channel(s), television channel(s), programming channel(s), television show(s), program(s), broadcast(s), or any other content, and/or one or more content provider broadcasting/transmitting systems, each of which can be used by or which can be associated with any television station, television broadcasting company or entity, radio station, radio broadcasting company or entity, a news organization, an educational entity, a gaming or game provider, or any other type or kind of content provider, regardless or size, which can broadcast or transmit any type or kind of content.

The apparatus of the present invention can also include one or more ratings computers, each of which can be utilized by, or associated with, any ratings reporting service or entity, or any company, entity, business, or individual, which or who provides any services, information, or products, pertaining to ratings or ratings information, and/or one or more marketing services computers, each of which can be utilized by, or associated with, any company, entity, business, or individual, which or who provides any marketing services or products, advertising services or products, marketing strategy services or products, and/or any provider of any goods, products, or services. The apparatus of the present invention can also include a social networking computer which can be associated with any social network company and social network entity, which utilizes, or which desires to be utilized in connection with, the apparatus of the present invention.

The apparatus of the present invention can also include any number of personal communication device each of which can be utilized by any individual, user, member, or entity, who or which utilizes the present invention, in order to communicate with, transmit signals, data, and/or information to, receive signals, data, and/or information from, or to access, or which can be linked with, or which can be wirelessly linked with, any of the central processing computers described herein. The personal communication device can also be utilized to communicate with, transmit signals, data, and/or information to, receive signals, data, and/or information from, or to access, or which can be linked with, or which can be wirelessly linked with, any of the herein-described television broadcasting/transmitting systems, the cable television broadcasting/transmitting systems, the satellite television broadcasting/transmitting systems, the content provider broadcasting/transmitting systems, the ratings computers, the marketing services computers, the social networking computer, and/or any other personal communication device(s).

Any of the central processing computers, the television broadcasting/transmitting systems, the cable television broadcasting/transmitting systems, the satellite television broadcasting/transmitting systems, the content provider broadcasting/transmitting systems, the ratings computers, the marketing services computers, the social networking computers, and/or any other personal communication devices, described herein can be utilized to communicate with, transmit signals, data, and/or information to, receive signals, data, and/or information from, or to access, any of the herein-described central processing computers, the television broadcasting/transmitting systems, the cable television broadcasting/transmitting systems, the satellite television broadcasting/transmitting systems, the content provider broadcasting/transmitting systems, the ratings computers, the marketing services computers, the social networking computer, and/or any other personal communication devices, described herein.

The apparatus of the present invention can also include a personal communication device which can be utilized by any individual, user, member, or entity who or which utilizes the present invention, in order to communicate with, transmit signals, data, and/or information to, receive signals, data, and/or information from, or to access, or which can be linked with, or which can be wirelessly linked with, any of the central processing computers described herein. The personal communication device can also be utilized to communicate with, transmit signals, data, and/or information to, receive signals, data, and/or information from, or to access, or which can be linked with, or which can be wirelessly linked with, any of the herein-described television broadcasting/transmitting systems, the cable television broadcasting/transmitting systems, the satellite television broadcasting/transmitting systems, the content provider broadcasting/transmitting systems, the ratings computers, the marketing services computers, the social networking computer, and/or any other personal communication device(s).

Any of the central processing computers, the television broadcasting/transmitting systems, the cable television broadcasting/transmitting systems, the satellite television broadcasting/transmitting systems, the content provider broadcasting/transmitting systems, the ratings computers, the marketing services computers, the social networking computer, and/or any other personal communication devices, described herein can be utilized to communicate with, transmit signals, data, and/or information to, receive signals, data, and/or information from, or to access, any of the herein-described central processing computers, the television broadcasting/transmitting systems, the cable television broadcasting/transmitting systems, the satellite television broadcasting/transmitting systems, the content provider broadcasting/transmitting systems, the ratings computers, the marketing services computers, the social networking computer, and/or any other personal communication devices, described herein.

The personal communication device can be a personal computer, a laptop computer, a notebook computer, a tablet computer, a cellular telephone, a personal digital assistant, a wireless telephone, a wireless communication device, a personal communication device, a personal communications services device, a smart phone, a mobile telephone, a hand-held device or computer, a palm-top device or computer, a watch, a telephone, a television, an interactive television, a digital television, a smart television or entertainment device, an internet-enabled television or entertainment device, or any other suitable device, which can be equipped to perform the functions described herein as being performed by the personal communication device.

The personal communication device can be utilized as a personal entertainment device or hub and can be utilized as a personal set-top box, a personal cable television box, a personal satellite television box, a personal gaming device or box, gaming console, or any other personal entertainment center, device, or hub. The personal communication device can include or contain any hardware, software, firmware, equipment, or any other devices or systems typically found in a set-top boxes, cable television boxes, satellite television boxes, gaming devices or boxes, gaming consoles, or any other entertainment centers, devices, or hubs.

The apparatus of the present invention can also include an entertainment device which can be a television, a monitor, a computer, a content player, a personal communication device, or any other entertainment device, or any combination of same.

The entertainment device can be connected to, such as by a wire, line, or cable, or wirelessly linked to, the personal communication device, and can be utilized in order to play, deliver, or otherwise, provide any of the content or entertainment content which can be provided to a user by or via the apparatus of the present invention. The apparatus of the present invention can also include a docking/interface device which can be utilized to connect any of the herein-described personal communication devices with any of the herein-described entertainment devices.

The apparatus of the present invention can be utilized on, and/or over, the Internet and/or the World Wide Web, and/or with any appropriate communication network or system such as, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems. The apparatus of the present invention can also utilize wireless Internet and/or World Wide Web services, equipment and/or devices. Any and/or all of the central processing computers, systems, or computers, utilizing in or with the present invention can have a website or websites associated therewith.

The present invention can be utilized in order to allow any individual, user, member, subscriber, or entity to create, establish, or set-up, a customized and/or personal television and/or entertainment account (hereinafter “personal entertainment account”). The personal entertainment account can be created, established, or set-up, by the user, and/or can be customized by the user so that it can include and provide the user with any of the channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, described herein as being provided by the apparatus of the present invention. The user can select any of the channel(s), television channel(s), programming channel(s), shows, movies, programs, news programs or shows, television programs or shows, radio programs or shows, informational programs or shows, entertainment programs or shows, sporting and/or athletic programs or shows, movies, educational programs or courses, advertisements, commercials, and/or marketing information, described herein for inclusion in his or her personal entertainment account.

The personal entertainment account can be customized to include entertainment content provided from a plurality of, and/or from different and/or separate, entertainment content providers, and/or from any number of, and/or any plurality of, and/or any combination of, and/or from different and/or separate, television broadcasting/transmitting systems, cable television broadcasting/transmitting systems, satellite television broadcasting/transmitting systems, and/or content provider broadcasting/transmitting systems. The personal entertainment account can include entertainment content from more than one broadcaster, transmitter, or provider of entertainment content or from more than one entertainment content provider. In this manner, the personal entertainment account can be customized to include entertainment content provided from a plurality of entertainment content providers and/or from different and/or separate entertainment content providers.

The personal entertainment account can include channel(s), television channel(s), programming channel(s), shows, movies, programs, news programs or shows, television programs or shows, radio programs or shows, informational programs or shows, entertainment programs or shows, sporting and/or athletic programs or shows, or educational programs or courses, and/or advertisements, commercials, and/or marketing information (hereinafter also referred to as “entertainment content”), which can be provided by any number of the herein-described television stations, cable television companies or service providers, satellite television companies or service providers, other television companies or service providers, content providers, radio stations, education institutions, game or gaming providers, or any other companies, service providers, or any other providers of any kind or type of content which can be suitable or desirable for providing via a personal entertainment account. In this regard, the personal entertainment account can be created, established, or set-up, to include and/or provide entertainment content from any number or a plurality of content providers. The personal entertainment account can also be set up or established to include or entertainment content from a single content provider if so desired.

Each personal entertainment account can be assigned to, can be personal to, can correspond to, or can be used by, a single user. The personal entertainment account can also be assigned to, can be personal to, or can correspond to, or can be used by, multiple users. The personal entertainment account can be customized by the user. The user can make changes to the content included in or provided by his or her personal entertainment account at any time or “on-the-fly”, with any such changes becoming effective immediately or at any other time.

The present invention can be utilized to provide any of the herein-described entertainment content to any individual, user, member, or subscriber, having a personal entertainment account, or having access or use of a personal entertainment account and via the personal communication device which can serve as a television set-top box, a personal cable television box, a personal satellite television box, a personal gaming device or box, a gaming console, or any other personal entertainment center, device, or hub. The apparatus of the present invention can be utilized in order to provide a respective individual, user, member, or subscriber, with his or her entertainment content made available in or from his or her personal entertainment account via a personal communication device and/or via a personal entertainment device used in connection with or along with an entertainment device.

The respective individual, user, member, or subscriber, can access and utilize the apparatus of the present invention to access entertainment content while at home, while away from home, while travelling, while in a vehicle, or from anywhere in the World and/or with any available personal communication device and/or entertainment device. In this regard, the respective individual, user, member, or subscriber, can, for example, be provided with hometown or local news, television shows or programming, television channels, or any other selected, favorite, or normally watched or received, entertainment content, channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, while travelling or away from home.

Any individual, user, member, or subscriber can utilize the present invention in order to access, view, receive, or otherwise be provided with, his or her entertainment content available in his or her personal entertainment account via his or her personal communication device. For example, the personal communication device can be utilized as a television set-top box, a personal cable television box, a personal satellite television box, a personal gaming device or box, a gaming console, or any other personal entertainment center, device, or hub, which can be connected to an entertainment device which can be a television, a digital television, an interactive television, or a smart television.

Any and/or all entertainment content provided by each of the herein-described television broadcasting/transmitting systems, cable television broadcasting/transmitting systems, satellite television broadcasting/transmitting systems, and content provider broadcasting/transmitting systems, can be continuously transmitted to or broadcast to the central processing computer so that the central processing computer can transmit or broadcast any and/or all entertainment content associated with or included in the user's personal entertainment account to the personal communication device. The present invention can also be utilized without a television or entertainment device. In such an embodiment, any and/or all entertainment content can be provided to the user via the personal communication device.

A user can also use the present invention in order to make changes to his or her personal entertainment account, add entertainment content or channels to his or her personal entertainment account, delete entertainment content or channels from his or her personal entertainment account, and/or make any other changes, set or establish criteria for receiving alerts or alert messages, place limitations or restrictions on the use of his or her personal entertainment account, and/or perform any other activity regarding same.

A user can also access ratings information, marketing information, marketing materials, commercials, and/or advertisements, and/or engage in ratings research activities or marketing research activities, using the present invention, and/or a user can access social networks and/or social networking computers and/or engage in social networking activities using the present invention. A user can also utilize the present invention to engage in electronic commerce transactions in order to purchase goods, products, and/or services, and/or an entertainment content such as movies, shows, songs, and/or any other media content or entertainment content.

The present invention can also be utilized to effectuate product or services placement advertising where goods, products, or services can be place in any of the herein-described entertainment content.

The present invention can also be utilized to allow a user to record entertainment content either when he or she is unable to view or listen to an airing of same, or for later and/or repeat viewing or listening. A user can request or instruct the apparatus or the central processing computer to record and store the entertainment content on a regular or repeated basis, such as when the user may desire to record a daily, weekly, or otherwise programmed or broadcast, program or show, or any other entertainment content, on a repeat and/or regular basis. A user can also program a personal communication device to record and store the entertainment content, which the user wants to record.

The apparatus of the present invention can be utilized in order to provide an individual, user, member, or subscriber, with entertainment content via his or her personal entertainment account while traveling and/or away from home. The present invention can also be utilized to provide a user with entertainment content regardless of the time zone difference between the user's home time zone, or registered time zone, and the time zone in which the user may be located while travelling and/or otherwise away from home. The central processing computer can also be programmed to search for and/or identify any commercials, advertisement, or marketing materials, or any coupons, discount coupons, or any other incentives to purchase, any goods, products, or services, identified as being offered in the geographical location, region, entertainment or media market, or time zone, in which the user is located or in or to which the user plans to travel.

The apparatus of the present invention can also be utilized to generate alerts, alert messages, notification messages, and/or any other type or kind of messages, and transmit same to a user's personal communication device. A user can also place limitations or restrictions or use of this or her personal entertainment account and the apparatus of the present invention can utilize the limitations or restrictions in processing any transaction, use, or activity, on or involving the user's personal entertainment account.

The present invention can also administer financial accounts, and/or can process financial transactions, and/or effectuate payments, for, on behalf of, or involving, any of the individual, users, members, or subscribers, who have personal entertainment accounts and/or who otherwise utilize the present invention, as well as administer financial accounts, and/or can process financial transactions, and/or effectuate payments, for, on behalf or, of involving, any of the companies, entities, or individuals, who either own, manage, or operate, any of the herein-described central processing computers, the television broadcasting/transmitting systems, the cable television broadcasting/transmitting systems, the satellite television broadcasting/transmitting systems, the content provider broadcasting/transmitting systems, the ratings computers, the marketing services computers, and/or the social networking computers, described herein.

The present invention provides an apparatus and methods for using same which provides a user with a personal entertainment account which can be customizable by the user and which can be utilized by the user while at home or away from home in order to access entertainment content utilizing any suitable personal communication device.

### BRIEF DESCRIPTION OF THE DRAWINGS

In the Drawings:

FIG. 1 illustrates a preferred embodiment of the present invention, in block diagram form;

FIG. 2 illustrates the central processing computer of FIG. 1, in block diagram form;

FIG. 3 illustrates the personal communication device of FIG. 1, in block diagram form;

FIG. 4 illustrates a preferred embodiment method of using the present invention, in flow diagram form;

FIG. 5 illustrates another preferred embodiment method of using the present invention, in flow diagram form;

FIGS. 6A and 6B illustrate still another preferred embodiment method of using the present invention, in flow diagram form; and

FIG. 7 illustrates another preferred embodiment method of using the present invention, in flow diagram form.

### DESCRIPTION OF THE PREFERRED EMBODIMENTS

The present invention pertains to an apparatus and method for providing a user customized and/or personal television and/or entertainment account and, in particular, the present invention pertains to an apparatus and method for providing a user customized and/or personal television and/or entertainment account which is customizable by the user and/or which can be accessed via a user communication device or a user's personal communication device.

Applicant hereby incorporates by reference herein the subject matter and teachings of U.S. Provisional Patent Application Ser. No. 61/850,602, filed Feb. 19, 2013, and entitled “APPARATUS AND METHOD FOR PROVIDING A USER CUSTOMIZED AND/OR PERSONAL TELEVISION AND/OR ENTERTAINMENT ACCOUNT”, the subject matter and teachings of which are hereby incorporated by reference herein in their entirety.

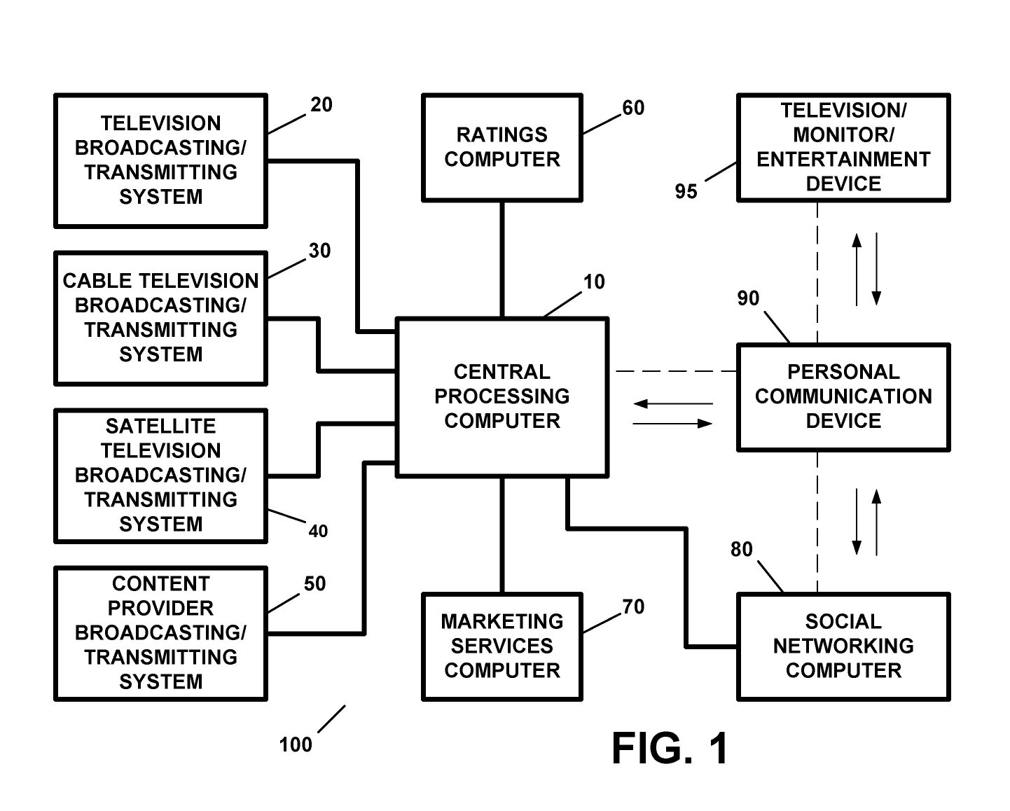

FIG. 1 illustrates a preferred embodiment of the apparatus 100 of the present invention which is denoted generally by the reference numeral 100. With reference to FIG. 1, the apparatus 100 includes a central processing computer 10 which can perform any of the processing routines and functionality described herein as being performed by the apparatus 100 of the present invention. In a preferred embodiment, the central processing computer 10 can be any computer, computer system, group of computers, server, server system, or group of servers which can be programmed and equipped to perform any of the herein-described functions, operations, or actions described herein as being performed by the central processing computer 10 and the apparatus 100 of the present invention. Any number of central processing computers 10 can be utilized in conjunction with the apparatus 100 of the present invention.

In another preferred embodiment, the central processing computers 10 can contain or include, or be equipped with, a digital video recording device, a digital audio recording device, a digital audio and video recording device, and/or any other device or equipment for allowing any of the user of the apparatus 100 of the present invention to record any live content described herein as being provided by the apparatus 100 of the present invention for replay at a later time in any appropriate manner and/or using any of the devices or equipment described herein.

In another preferred embodiment, any of the central processing computers 10 described as being utilized in connection or in conjunction with the apparatus 100 and method or the present invention can also be performed by or implemented using cloud computer hardware and/or software. In this regard, any and/or all of the central processing computers 10 described herein can be implements using a cloud computing architecture, server computers or network computers, and/or any cloud computing hardware and/or software.

In a preferred embodiment, the central processing computer 10 can receive and can broadcast and/or transmit any number of channels, television channels, programming channels, shows, movies, programs, broadcasts, news content, music, educational content, or any other type or kind of content, to any of the herein-described personal communication devices.

With reference once again to FIG. 1, the apparatus 100 also includes a television broadcasting/transmitting system 20 which can be used by or which can be associated with any television station or television broadcasting company or entity which can broadcast or transmit television a show(s), program(s), broadcast(s), channels, television channels, programming channels, or any other content. In a preferred embodiment, the television broadcasting/transmitting system 20 can include any needed or desired computers, processing devices, central processing devices, input devices, output devices, databases or memory devices and/or systems, random access memory (RAM) devices, read only memory (ROM) devices, video recording systems or equipment, cameras, audio recording systems or equipment, a microphone, receivers, transmitters, network interface devices, information or content gathering devices, and/or any other devices, equipments, or systems, typically found in and/or utilized by television stations or television broadcasting companies or entities.

In a preferred embodiment, the television broadcasting/transmitting system 20 can also contain, include, or be equipped with, a transmitter for transmitting a show(s), program(s), broadcast(s), channel(s), television channel(s), programming channel(s), or any other content, which can be a live show(s), program(s), broadcast(s), channel(s), television channel(s), programming channel(s) or any other content or a recorded show(s), program(s), broadcast(s), channel(s), television channel(s), programming channel(s) or any other content to the central processing computer 10 or the any of the herein-described computers, devices, personal communication devices and televisions, monitors, or entertainment devices described herein. In a preferred embodiment, the television broadcasting/transmitting system 20 can also contain, include, or be equipped with, a transmitter(s), a receiver(s), or any other network interface devices or equipment for facilitating bi-directional communication with, data and/or information exchange with, and/or remote control or remote programming by, the central processing computer 10 or the any of the herein-described computers, devices, personal communication devices and/or televisions, monitors, or entertainment devices described herein.

In another preferred embodiment, the television broadcasting/transmitting system 20 can contain or include, or be equipped with, a digital video recording device, a digital audio recording device, a digital audio and video recording device, and/or any other device or equipment for allowing any of the user of the apparatus 100 of the present invention to record any live content described herein as being provided by the television broadcasting/transmitting system 20 for replay at a later time in any appropriate manner and/or using any of the devices or equipment described herein.

In a preferred embodiment, the television broadcasting/transmitting system 20 can be connected with or linked with the central processing computer 10 via a wired or cable connection, via a wireless connection, or via any combination of same. Any number of television broadcasting/transmitter systems 20 can be utilized in the connection with the apparatus 100 and can be connected with or linked with the central processing computer 10. In a preferred embodiment, each television broadcasting/transmitting system 20 can transmit a show(s), program(s), broadcast(s), channel(s), television channel(s), programming channel(s) or any other content on, over or via, any one or more channels, means, or transmission link(s), or any other information transmission conduit(s).

In a preferred embodiment, a television broadcasting/transmitting system 20 can broadcast and/or transmit any number of channels, television channels, programming channels, shows, movies, programs, broadcasts, news content, music, educational content, or any other type or kind of content, to, and/or via, the central processing computer 10.

In a preferred embodiment, the television broadcasting/transmitting system 20 can broadcast and/or transmit any number of channels, television channels, programming channels, shows, movies, programs, broadcasts, news content, music, educational content, or any other type or kind of content, to the central processing computer 10 for re-transmission of same from the central processing computer 10 to any of the herein-described personal communication devices.

In a preferred embodiment, a link to, for, associated with, or corresponding to, each of the show(s), program(s), broadcast(s), a channel(s), television channel(s), programming channel(s) or any other content, can be provided by or to each television broadcasting/transmitting system 20 and can be stored in or at the central processing computer 10.

In a preferred embodiment, a link corresponding to or associated with each channel(s), television channel(s), programming channel(s), show(s), program(s), broadcast(s), channel(s), or any other content, can be provided by or to the television broadcasting/transmitting system 20 and can be utilized to broadcast and/or to transmit any of the channels, television channels, programming channels, shows, movies, programs, broadcasts, music, or content, to or via the central processing computer 10 as described herein or can be utilized to facilitate the transmission of, or the dissemination of, the show(s), program(s), broadcast(s), channel(s), television channel(s), programming channel(s), or any other content, from or via the respective television broadcasting/transmitting system 20 and/or the central processing computer 10.

With reference once again to FIG. 1, the apparatus 100 also includes a cable television broadcasting/transmitting system 30 which can be used by or which can be associated with any cable television station or cable television broadcasting company or entity which can broadcast or transmit any number of channel, television channels, programming channels, or any number of television show(s), program(s), broadcast(s), or any other content. The cable television broadcasting/transmitting system 30 can broadcast or transmit any number of television channels, or any number of television show(s), program(s), broadcast(s), channel(s), television channel(s), programming channel(s), or any other content form any number of television stations or television broadcasting companies or entities. In a preferred embodiment, the cable television broadcasting/transmitting system 30 can include any needed or desired computers, processing devices, central processing devices, input devices, output devices, databases or memory devices and/or systems, random access memory (RAM) devices, read only memory (ROM) devices, video recording systems or equipment, cameras, audio recording systems or equipment, receivers, transmitters, network interface devices, information or content gathering devices, and/or any other devices, equipments, or systems, typically found in and/or utilized by cable television stations or cable television broadcasting companies or entities.

In a preferred embodiment, the cable television broadcasting/transmitting system 30 can also contain, include, or be equipped with, a transmitter for transmitting a show(s), program(s), broadcast(s), channel(s), television channel(s), programming channel(s), or any other content, which can be a live show(s), program(s), broadcast(s), channel(s), television channel(s), programming channel(s), or any other content or a recorded channel(s), television channel(s), programming channel(s), show(s), program(s), broadcast(s), or any other content to the central processing computer 10 or the any of the herein-described computers, devices, personal communication devices and televisions, monitors, or entertainment devices described herein. In a preferred embodiment, the cable television broadcasting/transmitting system 30 can also contain, include, or be equipped with, a transmitter(s), a receiver(s), or any other network interface devices or equipment for facilitating bi-directional communication with, data and/or information exchange with, and/or remote control or remote programming by, the central processing computer 10 or the any of the herein-described computers, devices, personal communication devices and/or televisions, monitors, or entertainment devices described herein.

In another preferred embodiment, the cable television broadcasting/transmitting system 30 can contain or include, or be equipped with, a digital video recording device, a digital audio recording device, a digital audio and video recording device, and/or any other device or equipment for allowing any of the user of the apparatus 100 of the present invention to record any live content described herein as being provided by the cable television broadcasting/transmitting system 30 for replay at a later time in any appropriate manner and/or using any of the devices or equipment described herein.

In a preferred embodiment, the cable television broadcasting/transmitting system 30 can be connected with or linked with the central processing computer 10 via a wired or cable connection, via a wireless connection, or via any combination of same. Any number of cable television broadcasting/transmitter systems 30 can be utilized in the connection with the apparatus 100 and can be connected with or linked with the central processing computer 10. In a preferred embodiment, each cable television broadcasting/transmitting system 30 can transmit a channel(s), television channel(s), programming channel(s), show(s), program(s), broadcast(s), or any other content on, over or via, any one or more channels, means, or transmission link(s), or any other information transmission conduit(s).

In a preferred embodiment, a cable television broadcasting/transmitting system 30 can broadcast and/or transmit any number of channels, television channels, programming channels, shows, movies, programs, broadcasts, news content, music, educational content, or any other type or kind of content, to, and/or via, the central processing computer 10.

In a preferred embodiment, the cable television broadcasting/transmitting system 30 can broadcast and/or transmit any number of channels, television channels, programming channels, shows, movies, programs, broadcasts, news content, music, educational content, or any other type or kind of content, to the central processing computer 10 for re-transmission of same from the central processing computer 10 to any of the herein-described personal communication devices.

In a preferred embodiment, a link to, for, associated with, or corresponding to, each of the channel(s), television channel(s), programming channel(s), show(s), program(s), broadcast(s), or any other content, can be provided by or to each cable television broadcasting/transmitting system 30 and can be stored in or at the central processing computer 10.

In a preferred embodiment, a link corresponding to or associated with each channel(s), television channel(s), programming channel(s), show(s), program(s), broadcast(s), or any other content, provided by the cable television broadcasting/transmitting system 30 can be utilized to broadcast and/or transmit any of the cable television channels, shows, movies, programs, broadcasts, music, or content, via the central processing computer 10 as described herein or can be utilized to facilitate the transmission of, or the dissemination of, the channel(s), television channel(s), programming channel(s), show(s), program(s), broadcast(s), channel(s), or any other content, from or via the respective cable television broadcasting/transmitting system 30 and/or the central processing computer 10.

With reference once again to FIG. 1, the apparatus 100 also includes a satellite television broadcasting/transmitting system 40 which can be used by or which can be associated with any satellite television station or satellite television broadcasting company or entity which can broadcast or transmit any number of television channels, or any number of channel(s), television channel(s), programming channel(s), television show(s), program(s), broadcast(s), or any other content. The satellite television broadcasting/transmitting system 30 can broadcast or transmit any number of television channels, or any number of channel(s), television channel(s), programming channel(s), television show(s), program(s), broadcast(s), or any other content form any number of television stations or television broadcasting companies or entities. In a preferred embodiment, the satellite television broadcasting/transmitting system 40 can include any needed or desired satellites, computers, processing devices, central processing devices, input devices, output devices, databases or memory devices and/or systems, random access memory (RAM) devices, read only memory (ROM) devices, video recording systems or equipment, cameras, audio recording systems or equipment, receivers, transmitters, network interface devices, information or content gathering devices, and/or any other devices, equipments, or systems, typically found in and/or utilized by cable television stations or cable television broadcasting companies or entities.

In a preferred embodiment, the satellite television broadcasting/transmitting system 40 can also contain, include, or be equipped with, a transmitter for transmitting a channel(s), television channel(s), programming channel(s), show(s), program(s), broadcast(s), or any other content, which can be a live channel(s), television channel(s), programming channel(s), show(s), program(s), broadcast(s), or any other content or a recorded channel(s), television channel(s), programming channel(s), show(s), program(s), broadcast(s), or any other content to the central processing computer 10 or the any of the herein-described computers, devices, personal communication devices and televisions, monitors, or entertainment devices described herein. In a preferred embodiment, the satellite television broadcasting/transmitting system 40 can also contain, include, or be equipped with, a transmitter(s), a receiver(s), or any other network interface devices or equipment for facilitating bi-directional communication with, data and/or information exchange with, and/or remote control or remote programming by, the central processing computer 10 or the any of the herein-described computers, devices, personal communication devices and/or televisions, monitors, or entertainment devices described herein.

In another preferred embodiment, the satellite television broadcasting/transmitting system 40 can contain or include, or be equipped with, a digital video recording device, a digital audio recording device, a digital audio and video recording device, and/or any other device or equipment for allowing any of the user of the apparatus 100 of the present invention to record any live content described herein as being provided by the satellite television broadcasting/transmitting system 40 for replay at a later time in any appropriate manner and/or using any of the devices or equipment described herein.

In a preferred embodiment, the satellite television broadcasting/transmitting system 40, or any component of same, can be connected with or linked with the central processing computer 10 via a wired or cable connection, via a wireless connection, via satellite connection or feed, or via any combination of same. Any number of satellite television broadcasting/transmitter systems 40 can be utilized in the connection with the apparatus 100 and can be connected with or linked with the central processing computer 10. In a preferred embodiment, each satellite television broadcasting/transmitting system 40 can transmit a channel(s), television channel(s), programming channel(s), show(s), program(s), broadcast(s), or any other content on, over or via, any one or more channels, means, or transmission link(s), or any other information transmission conduit(s).

In a preferred embodiment, a satellite television broadcasting/transmitting system 40 can broadcast and/or transmit any number of channels, television channels, programming channels, shows, movies, programs, broadcasts, news content, music, educational content, or any other type or kind of content, to, and/or via, the central processing computer 10.

In a preferred embodiment, the satellite television broadcasting/transmitting system 40 can broadcast and/or transmit any number of channels, television channels, programming channels, shows, movies, programs, broadcasts, news content, music, educational content, or any other type or kind of content, to the central processing computer 10 for re-transmission of same from the central processing computer 10 to any of the herein-described personal communication devices.

In a preferred embodiment, a link to, for, associated with, or corresponding to, each of the channel(s), television channel(s), programming channel(s), show(s), program(s), broadcast(s), or any other content, can be provided by or to each satellite television broadcasting/transmitting system 40 and can be stored in or at the central processing computer 10.

In a preferred embodiment, a link corresponding to or associated with each channel(s), television channel(s), programming channel(s), show(s), program(s), broadcast(s), or any other content, can be provided by or to the satellite television broadcasting/transmitting system 40 and can be utilized to broadcast and/or transmit any of the satellite television channel(s), programming channel(s), shows, movies, programs, broadcasts, music, or content, via the central processing computer 10 as described herein or can be utilized to facilitate the transmission of, or the dissemination of, the channel(s), television channel(s), programming channel(s), show(s), program(s), broadcast(s), or any other content, from or via the respective satellite television broadcasting/transmitting system 40 and/or the central processing computer 10.

With reference once again to FIG. 1, the apparatus 100 also includes a content provider broadcasting/transmitting system 50 which can be used by or which can be associated with any television station, television broadcasting company or entity, radio station, radio broadcasting company or entity, a news organization, an educational entity, a gaming or game provider, or any other type or kind of content provider, regardless or size, which can broadcast or transmit any type or kind of content. It is important to note that the content provider can also be any television services provider other than a cable television company or service provider or a satellite television company or service provider. The content provider broadcasting/transmitting system 50 can broadcast or transmit any type or kinds, or any combination, of content. In a preferred embodiment, the content provider broadcasting/transmitting system 50 can include any needed or desired satellites, computers, processing devices, central processing devices, input devices, output devices, databases or memory devices and/or systems, random access memory (RAM) devices, read only memory (ROM) devices, video recording systems or equipment, cameras, audio recording systems or equipment, receivers, transmitters, network interface devices, information or content gathering devices, a gaming device for playing games, and/or any other devices, equipments, or systems, typically found in and/or utilized by a television station, television broadcasting company or entity, radio station, radio broadcasting company or entity, a news organization, an educational entity, a gaming or games provider or service, or any other type or kind of content provider.

In a preferred embodiment, the content provider broadcasting/transmitting system 50 can also contain, include, or be equipped with, a transmitter for transmitting a channel(s), television channel(s), programming channel(s), show(s), program(s), broadcast(s), or any other content, which can be a live channel(s), television channel(s), programming channel(s), show(s), program(s), broadcast(s), or any other content or a recorded channel(s), television channel(s), programming channel(s), show(s), program(s), broadcast(s), or any other content to the central processing computer 10 or the any of the herein-described computers, devices, personal communication devices and televisions, monitors, or entertainment devices described herein. In a preferred embodiment, the content provider broadcasting/transmitting system 50 can also contain, include, or be equipped with, a transmitter(s), a receiver(s), or any other network interface devices or equipment for facilitating bi-directional communication with, data and/or information exchange with, and/or remote control or remote programming by, the central processing computer 10 or the any of the herein-described computers, devices, personal communication devices and/or televisions, monitors, or entertainment devices described herein.

In another preferred embodiment, the content provider broadcasting/transmitting system 50 can contain or include, or be equipped with, a digital video recording device, a digital audio recording device, a digital audio and video recording device, and/or any other device or equipment for allowing any of the user of the apparatus 100 of the present invention to record any live content described herein as being provided by the content provider broadcasting/transmitting system 50 for replay at a later time in any appropriate manner and/or using any of the devices or equipment described herein.

In a preferred embodiment, the content provider broadcasting/transmitting system 50, or any component of same, can be connected with or linked with the central processing computer 10 via a wired or cable connection, via a wireless connection, via satellite connection or feed, or via any combination of same. Any number of content provider broadcasting/transmitting systems 50 can be utilized in the connection with the apparatus 100 and can be connected with or linked with the central processing computer 10. In a preferred embodiment, each content provider broadcasting/transmitting system 50 can transmit a channel(s), television channel(s), programming channel(s), show(s), program(s), broadcast(s), or any other content on, over or via, any one or more channels, means, or transmission link(s), or any other information transmission conduit(s).

In a preferred embodiment, a content provider broadcasting/transmitting system 50 can broadcast and/or transmit any number of television channels, programming channels shows, movies, programs, broadcasts, radio stations, programs, or broadcasts, news content, music, educational content, or any other type or kind of content, to, and/or via, the central processing computer 10.

In a preferred embodiment, the content provider broadcasting/transmitting system 50 can broadcast and/or transmit any number of television channels, programming channels shows, movies, programs, broadcasts, radio stations, programs, or broadcasts, news content, music, educational content, or any other type or kind of content, to the central processing computer 10 for re-transmission of same from the central processing computer 10 to any of the herein-described personal communication devices.

In a preferred embodiment, a link to, for, associated with, or corresponding to, each of the channel(s), television channel(s), programming channel(s), show(s), program(s), broadcast(s), a channel(s), or any other content, can be provided by or to each content provider broadcasting/transmitting system 50 and can be stored in or at the central processing computer 10. In a preferred embodiment, a link corresponding to or associated with each channel(s), television channel(s), programming channel(s), show(s), program(s), broadcast(s), channel(s), or any other content, can be provided by or to the content provider broadcasting/transmitting system 50 and can be utilized to broadcast and/or transmit any of the channel(s), television channel(s), programming channel(s), shows, movies, programs, broadcasts, music, or content, via the central processing computer 10 as described herein or can be utilized to facilitate the transmission of, or the dissemination of, the channel(s), television channel(s), programming channel(s), show(s), program(s), broadcast(s), channel(s), or any other content, from or via the respective content provider broadcasting/transmitting system 50 and/or the central processing computer 10.

With reference once again to FIG. 1, the apparatus 100 also includes a ratings computer 60 which is connected to or linked with the central processing computer 10. In a preferred embodiment, a ratings computer 60 can be utilized by, or associated with, any ratings reporting service or entity, or any company, entity, business, or individual, which or who provides any services, information, or products, pertaining to ratings or ratings information. The ratings computer 60, in a preferred embodiment, can be utilized to record, receive, and/or store information regarding various ratings and viewership information or listenership information for any of the various channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, described herein as being provided by the apparatus 100 of the present invention. In a preferred embodiment, the ratings computer 60 can include a central processing device, an input device(s), an output device(s), a database(s) or memory device(s) and/or system(s), a random access memory (RAM) device(s), a read only memory (ROM) device(s), a receiver(s), a transmitter(s), a network interface device(s), and/or any other hardware, software, device, equipment, or system, which can typically be found in and/or utilized by a computer or computer system used to perform the functionality of the ratings computer 60 described herein. Any number of ratings computers 60 can be utilized in the apparatus 100.

In a preferred embodiment, a link to, for, associated with, or corresponding to, each ratings computer 60 can also be stored in or at the central processing computer 10. In a preferred embodiment, a link corresponding to or associated with information stored at or provided by each ratings computer 60 can be utilized to access and/or to obtain information from a respective ratings computer 60 ether directly or via the central processing computer 10.

In a preferred embodiment, the ratings computer 60 can also contain, include, or be equipped with, a transmitter(s), a receiver(s), or any other network interface devices or equipment for facilitating bi-directional communication with, data and/or information exchange with, and/or remote control or remote programming by, the central processing computer 10 or the any of the herein-described broadcasting/transmitting systems 20, 30, 40, or 50, computers, devices, personal communication devices and/or televisions, monitors, or entertainment devices described herein.

With reference once again to FIG. 1, the apparatus 100 also includes a marketing services computer 70 which is connected to or linked with the central processing computer 10. In a preferred embodiment, a marketing services computer 70 can be utilized by, or associated with, any company, entity, business, or individual, which or who provides any marketing services or products, advertising services or products, marketing strategy services or products, and/or any provider of any goods, products, or services, which might desire to utilize a marketing services computer 70 in utilizing the apparatus 100 of the present invention.

The marketing services computer 70 can be utilized to store and provide advertisements, commercials, and marketing materials. The advertisements and/or commercials can include commercials can include television, radio, Internet, and/or video and audio, commercials, infomercials, video advertisements, video clips, audio advertisements, audio clips, banner advertisements, button advertisements, logos, icons, and/or any other information which can be utilized as an advertisement or commercial, or any other advertisement(s) or marketing material(s) which can be provided to any user of the apparatus 100 in any manner or form. In a preferred embodiment, any marketing materials can also include surveys, questionnaires, and/or any other materials, which can be utilized in performing marketing research, market research, marketing planning and strategic planning, and/or any other information which can be used for gathering marketing information. In a preferred embodiment, the marketing services computer 70 can include a central processing device, an input device(s), an output device(s), a database(s) or memory device(s) and/or system(s), a random access memory (RAM) device(s), a read only memory (ROM) device(s), a receiver(s), a transmitter(s), a network interface device(s), and/or any other hardware, software, device, equipment, or system, which can typically be found in and/or utilized by a computer or computer system used to perform the functionality of the marketing services computer 70 described herein. Any number of marketing services computers 70 can be utilized in the apparatus 100.

In a preferred embodiment, a link to, for, associated with, or corresponding to, each marketing services computers 70 can also be stored in or at the central processing computer 10. In a preferred embodiment, a link corresponding to or associated with information stored at or provided by each marketing services computers 70 can be utilized to access and/or to obtain information from a respective marketing services computers 70 ether directly or via the central processing computer 10.

In a preferred embodiment, the marketing services computers 70 can also contain, include, or be equipped with, a transmitter(s), a receiver(s), or any other network interface devices or equipment for facilitating bi-directional communication with, data and/or information exchange with, and/or remote control or remote programming by, the central processing computer 10 or the any of the herein-described broadcasting/transmitting systems 20, 30, 40, or 50, computers, devices, personal communication devices and/or televisions, monitors, or entertainment devices described herein.

With reference once again to FIG. 1, the apparatus 100 also includes a social networking computer 80 which can be connected with or otherwise linked with the central processing computer 10. In a preferred embodiment, the social networking computer can be associated with any social network company and social network entity, which utilizes, or which desires to be utilized in connection with, the apparatus 100 of the present invention, and can include a public social network or a private social network. In the preferred embodiment, any number of social networking computers 80 can be utilized and each social networking computer 80 can be associated with or can service any number of public social networks, private social networks, or any combination of same. In a preferred embodiment, the social networking computer 80 can include a central processing device, an input device(s), an output device(s), a database(s) or memory device(s) and/or system(s), a random access memory (RAM) device(s), a read only memory (ROM) device(s), a receiver(s), a transmitter(s), a network interface device(s), and/or any other hardware, software, device, equipment, or system, which can typically be found in and/or utilized by a computer or computer system used to perform the functionality of the social networking computer 80 described herein. Each social networking computer 80 can also be equipped with hardware and/or software for performing any feature or function, or functionality, which can be performed or supported by the social networking computer 80 described herein.

In a preferred embodiment, a link to, for, associated with, or corresponding to, each social networking computer 80 can also be stored in or at the central processing computer 10. In a preferred embodiment, a link corresponding to or associated with information stored at or provided by each social networking computer 80 can be utilized to access and/or to obtain information from a respective social networking computer 80 ether directly or via the central processing computer 10.

In a preferred embodiment, the social networking computer 80 can also contain, include, or be equipped with, a transmitter(s), a receiver(s), or any other network interface devices or equipment for facilitating bi-directional communication with, data and/or information exchange with, and/or remote control or remote programming by, the central processing computer 10 or the any of the herein-described broadcasting/transmitting systems 20, 30, 40, or 50, computers, devices, personal communication devices and/or televisions, monitors, or entertainment devices described herein.

With reference once again to FIG. 1, the apparatus 100 also includes a personal communication device 90 which can be utilized by any individual, user, member, or entity (hereinafter as referred to as “user”) who or which utilizes the apparatus 10 of the present invention, in order to communicate with, transmit signals, data, and/or information to, receive signals, data, and/or information from, or to access, or which can be linked with, or which can be wirelessly linked with, any of the central processing computers 10 described herein. In a preferred embodiment, the personal communication device 90 can also be utilized to communicate with, transmit signals, data, and/or information to, receive signals, data, and/or information from, or to access, or which can be linked with, or which can be wirelessly linked with, any of the television broadcasting/transmitting systems 20, the cable television broadcasting/transmitting systems 30, the satellite television broadcasting/transmitting systems 40, the content provider broadcasting/transmitting systems 50, the ratings computers 60, the marketing services computers 70, the social networking computer 80, and/or any other personal communication devices 90, described herein. In a preferred embodiment, any of the central processing computers 10, the television broadcasting/transmitting systems 20, the cable television broadcasting/transmitting systems 30, the satellite television broadcasting/transmitting systems 40, the content provider broadcasting/transmitting systems 50, the ratings computers 60, the marketing services computers 70, the social networking computer 80, and/or any other personal communication devices 90, described herein can be utilized to communicate with, transmit signals, data, and/or information to, receive signals, data, and/or information from, or to access, any of the central processing computers 10, the television broadcasting/transmitting systems 20, the cable television broadcasting/transmitting systems 30, the satellite television broadcasting/transmitting systems 40, the content provider broadcasting/transmitting systems 50, the ratings computers 60, the marketing services computers 70, the social networking computer 80, and/or any other personal communication devices 90, described herein.

In a preferred embodiment, the personal communication device 90 can be a personal computer, a laptop computer, a notebook computer, a tablet computer, a cellular telephone, a personal digital assistant, a wireless telephone, a wireless communication device, a personal communication device, personal communications services device, a smart phone, a mobile telephone, a hand-held device or computer, a palm-top device or computer, a watch, a telephone, a television, an interactive television, a digital television, a smart television or entertainment device, an internet-enabled television or entertainment device, or any other suitable device, which can be equipped to perform the functions described herein as being performed by the personal communication device 90. In a preferred embodiment, the personal communication device 90 can include a central processing unit or device, an input device, a pointing device, a mouse, an output device, a database or a memory device and/or system, a random access memory (RAM) device, a read only memory (ROM) device, a video recording system or equipment, a camera(s), an audio recording system, device, or equipment, a microphone, a receiver or any number of receivers, a transmitter or any number of transmitters, a network interface device, an information or content gathering device, and/or any other devices, equipments, or systems, typically found in and/or utilized by any of the herein-described personal communication devices 90 described herein as being utilized in connection with the apparatus 100 of the present invention. In a preferred embodiment, the personal communication device 90 can also be equipped with a global positioning device which can be utilized to calculate, determine, or ascertain, the position or location of the personal communication device 90.

In a preferred embodiment, the personal communication device 90 can also contain, include, or be equipped with, a transmitter(s), a receiver(s), or any other network interface devices or equipment for facilitating bi-directional communication with, data and/or information exchange with, and/or remote control or remote programming by, the central processing computer 10 or the any of the herein-described broadcasting/transmitting systems 20, 30, 40, or 50, ratings computers 60, marketing services computers 70, social networking computers 80, computers, devices, any of the other personal communication devices 90, and/or any televisions, monitors, or entertainment devices 95 described herein. In a preferred embodiment, the personal communication device 90 can also transmit, from its transmitter or any one or more of its transmitters, the location or position information, which is calculated, determined, or ascertained, by the global positioning device, to the central processing computer or to any one or more of the herein-described broadcasting/transmitting systems 20, 30, 40, or 50, ratings computers 60, marketing services computers 70, social networking computers 80, computers, devices, any of the other personal communication devices 90 described herein.

In a preferred embodiment, the personal communication device 90 can be utilized as a personal entertainment device or hub and can be utilized as a personal set-top box, a personal cable television box, a personal satellite television box, a personal gaming device or box, gaming console, or any other personal entertainment center, device, or hub. In a preferred embodiment, the personal communication device 90 can also include or contain any hardware, software, firmware, equipment, or any other devices or systems typically found in a set-top boxes, cable television boxes, satellite television boxes, gaming devices or boxes, gaming consoles, or any other entertainment centers, devices, or hubs. In this manner, the personal communication device 90 and the apparatus 100 of the present invention can be utilized to provide or to facilitate a personal and/or portable personal entertainment system.

In this regard, in a preferred embodiment, the personal communication device 90 can include, contain, or be equipped with any hardware, software, firmware, or any other technology or equipment, typically found in or included in a television set-top box, a personal cable television box, a personal satellite television box, a personal gaming device or box, or any other personal entertainment center, device, or hub.

In a preferred embodiment, the personal communication device 90 can also include, contain, or be equipped with a digital video recording system or equipment, a digital audio recording system or equipment, or any another digital video and audio recording device or equipment or other digital media recoding equipment, that can allow the personal communication device 90 to record and store, for later play-back, any of the content or entertainment content described herein as being provided by or via the apparatus 100 of the present invention. In another preferred embodiment, the personal communication device 90 can be equipped with any an all necessary or desired transmitters, receivers, interface devices, ports, and any other equipment or devices for enabling the personal communication device 90 to be linked, either by wire or wirelessly, with a television or any other entertainment device or player, in order to allow a user to view, play, or receive, any of the herein-described content, via a television, a monitor, a computer, or any other device, equipment, or system, or any other personal communication device 90.

In another preferred embodiment, the personal communication device 90 can contain or include, or be equipped with, a digital video recording device, a digital audio recording device, a digital audio and video recording device, and/or any other device or equipment for allowing a user to record any live content described herein as being provided by the apparatus 100 of the present invention for replay at a later a later time in any appropriate manner and via the personal communication device 90 and/or any appropriate television, a monitor, a computer, or any other device, equipment, or system, or any other personal communication device 90.

In a preferred embodiment, any number of personal communication devices 90 can be assigned to, utilized with, or associated with, and of the herein-described personal television accounts or personal entertainment accounts.

With reference once again to FIG. 1, the apparatus 100 also includes a television/monitor/entertainment device 95 (also referred to herein as an “entertainment device 95” or “television 95”). In a preferred embodiment, the entertainment device 95 can be a television, a monitor, a computer, a content player, or any other personal communication device 90, or combination of same. In a preferred embodiment, the entertainment device 95 can be connected to, such as by a wire, line, or cable, or wirelessly linked to, the personal communication device 90. In a preferred embodiment, if utilized, the entertainment device 95 can be utilized in order to play, deliver, or otherwise, provide any of the content, described herein as being provided to a user by or via the apparatus 100 of the present invention.

In a preferred embodiment, the entertainment device 95 can include a receiver or an input device, channel, port, or other entity, for receiving or in taking, from the personal communication device 90, any of the herein-described channels, television channels, programming channels, shows, movies, programs, channels, music, or content, and/or any other data or information, described herein as being provided by or via the apparatus 100 of the present invention. In a preferred embodiment, the entertainment device 95 can also be equipped as a smart television or can be equipped with a wireless or WiFi communication equipment so as to receive any of the herein-described channels, television channels, programming channels, shows, movies, programs, channels, music, or content, and/or any other data or information, from the personal communication device 90.

In a preferred embodiment, the entertainment device 95 can also contain, include, or be equipped with, a transmitter(s), a receiver(s), or any other network interface devices or equipment for facilitating bi-directional communication with, data and/or information exchange with, and/or remote control or remote programming by, the central processing computer 10 or the any of the herein-described broadcasting/transmitting systems 20, 30, 40, or 50, computers, ratings computers 60, marketing services computers 70, social networking computers 80, devices, personal communication devices 90 and any other televisions, monitors, or entertainment devices 95 described herein.

In a preferred embodiment, the apparatus 100 of the present invention can also include a docking/interface device 98 (not shown) which can be utilized to connect any of the herein-described personal communication devices 90 with any of the herein-described entertainment devices 95. In a preferred embodiment, the interface device 98 can be any suitable device designed for each type or personal communication device 90 that can be utilized. In a preferred embodiment, the docking/interface device 98 can be a portable device, a set-top box or set-top device, or a stationary device. In another preferred embodiment, the docking/interface device 98 can be integrated with or into, attachable to, or connected to, the entertainment device 95.

In a preferred embodiment, the docking/interface device 98 can be connected to the entertainment device 95 by a physical connector, wire, or cable, and/or can be wirelessly linked to or with the entertainment device 95. The docking/interface device 98 can also be integrated into or with, attachable to, or connected with or to, the personal communication device 90 or can include a cradle or other member for receiving or mounting same. In a preferred embodiment, the docking/interface device 98 can be connected to or with the personal communication device 90 by a physical connector, wire, or cable, and/or can be wirelessly linked to or with the personal communication device 90.

In the preferred embodiment, the apparatus 100 of the present invention is utilized on, and/or over, the Internet and/or the World Wide Web. The apparatus 100 of the present invention, in the preferred embodiment, can also utilize wireless Internet and/or World Wide Web services, equipment and/or devices. The central processing computer(s) 10, in the preferred embodiment, has a web site or web sites associated therewith. Each of the television broadcasting/transmitting systems 20, the cable television broadcasting/transmitting systems 30, the satellite television broadcasting/transmitting systems 40, the content provider broadcasting/transmitting systems 50, the ratings computers 60, the marketing services computers 70, the social networking computer 80, and/or any other personal communication devices 90, described herein can also have a web site or web sites associated with same.

Although the Internet and/or the World Wide Web is a preferred communication system, network, and/or medium, utilized, the present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

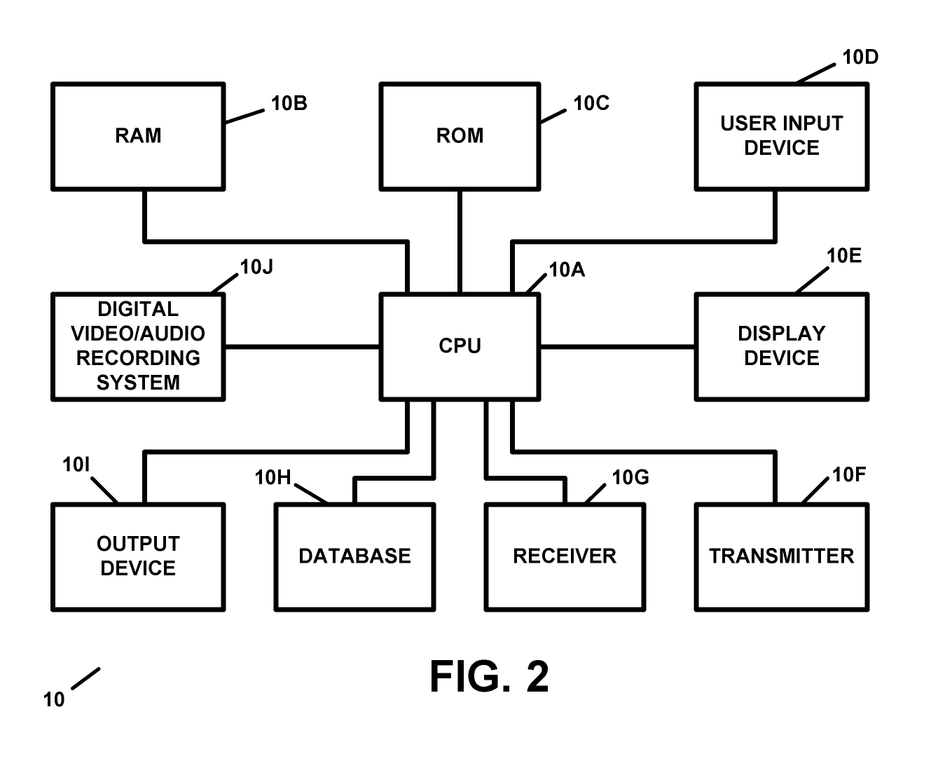

FIG. 2 illustrates a preferred embodiment of the central processing computer 10 of FIG. 1, in block diagram form. The central processing computer 10, in the preferred embodiment, is a network computer or computer system, or any other communication device which can provide the functionality of, and which can be utilized as a central processing computer 10 such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, and a user input device 10D, for entering data and/or commands into the central processing computer 10, which includes any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise which can be utilized for inputting and/or entering data and/or information, of any kind or type pertinent to the operation of the apparatus 100 of the present invention, into the central processing computer 10. The input devices 10D are also connected to or with, or linked to or with, the CPU 10A. The central processing computer 10 also includes a display device 10E for displaying data and/or information to a user or operator.

The central processing computer 10 also includes a transmitter(s) 10F, for transmitting signals and/or data and/or information to any one or more of the television broadcasting/transmitting systems 20, the cable television broadcasting/transmitting systems 30, the satellite television broadcasting/transmitting systems 40, the content provider broadcasting/transmitting systems 50, the ratings computers 60, the marketing services computers 70, the social networking computer 80, the personal communication devices 90, and/or to any of the televisions, monitors, and/or entertainment devices 95, described herein, and/or to any other central processing computers 10.

The central processing computer 10 also includes a receiver(s) 10G, for receiving signals and/or data and/or information from any one or more of the television broadcasting/transmitting systems 20, the cable television broadcasting/transmitting systems 30, the satellite television broadcasting/transmitting systems 40, the content provider broadcasting/transmitting systems 50, the ratings computers 60, the marketing services computers 70, the social networking computer 80, the personal communication devices 90, and/or from any of the televisions, monitors, and/or entertainment devices 95, described herein, and/or from any other central processing computers 10.

The central processing computer 10 also includes a database(s) 10H, which is also connected to or linked with the CPU 10A, which can contain any and/or all of the data and/or information needed for performing any and/or all of the functions and/or functionality described herein as being performed by the apparatus 100 and method of the present invention. In a preferred embodiment, the database 10 contains or includes data and/or information regarding any of the individuals, users, members, or other entities, who or which utilize the apparatus 100 of the present invention, including, but not limited to, his, her, or its, name, address, telephone number(s), cellular telephone number(s), wireless telephone number(s), personal communication device telephone number(s), e-mail address(es), text message number(s) or information, SMS message(s) or information, account information, account information regarding accounts of relatives or friends, gender, sex, demographic information, education information, information regarding the time zone of address on file in the individual's, user's, member's, or entity's, account, information regarding occupation (if applicable), information regarding schooling, hobby information, information regarding interests, likes, or dislikes, account information regarding content, channels, television channels, programming channels, shows, movies, programs, broadcasts, music, news show or programs, and/or games or gaming content, and/or any other content and/or any information regarding any television stations, cable television companies, satellite television stations, content providers, radio stations, or any other provider of any content or services which provide same.

The database 10H can also include or contain, for each individual, user, member, or subscriber, information regarding that respective individual's, user's, member's, or subscriber's, personal entertainment account, which can include any and/or all of the television stations, cable television companies, satellite television stations, content providers, radio stations, or any other provider of any content or services, or any channel(s), television channel(s), programming channel(s), show(s), program(s), broadcast(s), or any other content, of same, or any channel(s), show(s), program(s), broadcast(s), or any other content, selected by or subscribed to by the respective individual, user, member, or subscriber, or which are or may be otherwise included in the respective individual's, user's, member's, or subscriber's, personal entertainment account. The database 10H can also contain or include any link, links, hyperlink, or hyperlinks, to any and/or all of the television stations, cable television companies, satellite television stations, content providers, radio stations, or any other provider of any content or services, or any channel(s), television channel(s), programming channel(s), show(s), program(s), broadcast(s), or any other content, of same, or any channel(s), television channel(s), programming channel(s), show(s), program(s), broadcast(s), or any other content, selected by or subscribed to by the respective individual, user, member, or subscriber, or which are or may be otherwise included in the respective individual's, user's, member's, or subscriber's, personal entertainment account.

The database 10H can also contain or include any data and/or information regarding the individual's, user's, member's, or entity's personal communication device(s) 95 and any entertainment devices 95 which can be, or which are to be or might be, used in connection with the individual's, user's, member's, or entity's, account or personal communication device 90. The database 10H can also contain or include any data and/or information regarding an individual's, user's, member's, or entity's, content requests, content scheduling requests, travelling schedules, trip schedules, and/or any other data and/or information. The database 10H can also contain or include any data and/or information regarding an individual's, user's, member's, or entity's, request to record content, channel(s), television channel(s), programming channel(s), shows, movies, programs, broadcasts, channels, music, news shows or programs, and/or games or gaming content, and/or any other content and/or any information, for later viewing or listening. The database 10H can also contain or include any data and/or information regarding an individual's, user's, member's, or entity's, viewing habits or listening habits.

The database 10H can also contain or include information regarding an individual's, user's, members, or entity's, credit card, debit card, charge card, bank account, ATM account, savings account, checking account, brokerage account, electronic money account, or any other payment account or on-line payment account or mechanism, and/or any other pertinent financial information regarding accounts which any of the herein-described individuals, users, members, or entities, might use in conducting financial transactions. The database 10H can also contain or include, for each television station, television broadcasting company or entity, radio station, radio broadcasting company or entity, a news organization, an educational entity, a gaming or game provider, cable television company, entity, or provider, satellite television company, entity, or provider, or any content provider of any type or kind, which or who utilize the apparatus 100 and method of the present invention, data and/or information regarding the content, channel(s), television channel(s), programming channel(s), shows, movies, programs, music, educational materials, and/or games, provided by same, the schedules of same, the programming schedule(s) for or corresponding to each television station, television broadcasting company or entity, radio station, radio broadcasting company or entity, a news organization, an educational entity, a gaming or game provider, cable television company, entity, or provider, satellite television company, entity, or provider, or any content provider, a link, links, hyperlink, or hyperlinks, to the content, channels, television channels, programming channels, shows, movies, programs, channels, music, educational materials, and/or games, provided by same, the schedules of same, the programming schedule(s) for or corresponding to each television station, television broadcasting company or entity, radio station, radio broadcasting company or entity, a news organization, an educational entity, a gaming or game provider, cable television company, entity, or provider, satellite television company, entity, or provider, or any content provider, and information regarding each content, channel, television channel, programming channel, show, program, channel, educational material, game, cast members, performers, participants or employees involved in same, newscasters, actors, actresses, screen writers, producers, sponsors, advertisers, promoters, ratings, ratings information, product placement information, and/or any other data and/or information regarding same.

The database 10H can also contain or include, for each television station, television broadcasting company or entity, radio station, radio broadcasting company or entity, a news organization, an educational entity, a gaming or game provider, cable television company, entity, or provider, satellite television company, entity, or provider, or any content provider of any type or kind, which or who utilize the apparatus 100 and method of the present invention, recordings of content, channels, television channels, programming channels, shows, movies, programs, channels, music, educational materials, and/or games, provided by same, the schedules of same, the programming schedule(s) for or corresponding to each television station, television broadcasting company or entity, radio station, radio broadcasting company or entity, a news organization, an educational entity, a gaming or game provider, cable television company, entity, or provider, satellite television company, entity, or provider, or any content provider, as well as link, links, hyperlink, or hyperlinks, to any recorded content, channels, television channels, programming channels, shows, movies, programs, music, educational materials, and/or games, provided by same, the schedules of same, and the programming schedule(s) for or corresponding to each television station, television broadcasting company or entity, radio station, radio broadcasting company or entity, a news organization, an educational entity, a gaming or game provider, cable television company, entity, or provider, satellite television company, entity, or provider, or any content provider, and recordings of, or stored information regarding, same.

The database 10H can also contain or include any and/or all data and/or information regarding, and/or which can be stored in any databases or memory devices in or associated with, any of the television broadcasting/transmitting systems 20, cable television broadcasting/transmitting systems 30, satellite television broadcasting/transmitting systems 40, content provider broadcasting/transmitting systems 50, of, associated with, or utilized by, any of the television stations, television broadcasting companies or entities, radio stations, radio broadcasting companies or entities, news organizations, educational entities, gaming or game providers, cable television companies, entities, or providers, satellite television companies, entities, or providers, or any content providers of any type or kind, which or who utilize the apparatus 100 and method of the present invention, including, but limited to, any and/or all content, channels, television channels, programming channels, shows, movies, programs, music, educational materials, and/or games, provided by same, the schedules of same, the programming schedule(s) of same, and information regarding each content, channel, television channel, programming channel, show, program, educational material, game, and cast members, performers, participants or employees involved in same, newscasters, actors, actresses, screen writers, producers, sponsors, advertisers, promoters, ratings, ratings information, product placement information, and/or any other data and/or information regarding same.

In a preferred embodiment, any and/or all data and/or information stored in, utilized by or at, or provided by any of, the television broadcasting/transmitting systems 20, cable television broadcasting/transmitting systems 30, satellite television broadcasting/transmitting systems 40, content provider broadcasting/transmitting systems 50, of, associated with, or utilized by, any of the television stations, television broadcasting companies or entities, radio stations, radio broadcasting companies or entities, news organizations, educational entities, gaming or game providers, cable television companies, entities, or providers, satellite television companies, entities, or providers, or any content providers of any type or kind, which or who utilize the apparatus 100 and method of the present invention, including any and/or all content, channels, television channels, programming channels, shows, movies, programs, music, educational materials, and/or games, provider by or from same, can also be stored in the database 10H and/or in or at any other memory devices or storage devices of or associated with the central processing computer 10.

The database 10H can also contain or include any and/or all data and/or information pertaining to utilizing and/or providing any of the herein-described data, information, any of the any and/or all content, channels, television channels, programming channels, shows, movies, programs, music, educational materials, and/or games, described herein as being provided by or via the apparatus 100.

The database 10H can also contain or include time zone information for all of the television stations, television broadcasting companies or entities, radio stations, radio broadcasting companies or entities, news organizations, educational entities, gaming or game providers, cable television companies, entities, or providers, satellite television companies, entities, or providers, or any content providers of any type or kind, which or who utilize the apparatus 100 and method of the present invention, as well as any other data and/or information needed or desired for performing of the functions and functionality described herein regarding any providing of any and/or all content, channels, television channels, programming channels, shows, movies, programs, music, educational materials, and/or games, to an individual, user, member, or subscriber who may be located or situated in a time zone, which may be different time zone from a time zone in which a television station, television broadcasting company or entity, radio station, radio broadcasting company or entity, news organization, educational entity, gaming or game provider, cable television company, entity, or provider, satellite television company, entity, or provider, or any other content provider, is located or situated.

The database 10H can also contain or include time zone information associated with the personal entertainment account(s) of any and/or all of the individuals, users, members, or subscribers, having same, as well as time zone information for times zones for locations in which the respective individuals, users, members, or subscribers, may be located at any given time or when travelling or when otherwise away home.

The database 10H can also contain or include, for each and every ratings service organization, or for each and/or every ratings company, business, entity, or individual which or who utilizes a ratings computer 60, any data and/or information stored in or at each respective ratings computer 60, any data and/or information used by each respective ratings computer 60, and/or any and/or all data and/or information, stored at or in, or provided by, each respective ratings computer 60, information regarding various ratings, viewership information, listenership information, and/or usership information, for any of the various content, channels, television channels, programming channels, shows, movies, programs, music, educational materials, and/or games, described herein as being provided by or via the apparatus 100, as well as any ratings information regarding advertisements, commercials, and/or marketing information, which can also be provided by the apparatus 100 of the present invention.

The database 10H can also contain or include ratings information regarding actors, actress, performers, celebrities, and any other individuals or participants of any of the channels, television channels, programming channels, shows, movies, various content, shows, movies, programs, music, educational materials, and/or games, described herein as being provided by or via the apparatus 100. For example, ratings information for an actor or actress, an athlete, a news reporter or television personality, a musician, a singer, or any other individual appearing in or associated with any of the channels, television channels, programming channels, shows, movies, various content, shows, movies, programs, music, educational materials, and/or games, described herein as being provided by or via the apparatus 100, can also be stored in the database 10H.

The database 10H can also contain or include ratings information regarding any goods, products, or services, which may appear in, or which may be associated with any advertisements or sponsors of, any of the channels, television channels, programming channels, shows, movies, various content, shows, programs, music, educational materials, and/or games, described herein as being provided by or via the apparatus 100. For example, ratings information for a good, a products or a services which might be placed in or identified in, or appear in an advertisement during or in, any of the channels, television channels, programming channels, shows, movies, various content, shows, programs, music, educational materials, and/or games, described herein as being provided by or via the apparatus 100, can also be stored in the database 10H.

The database 10H can also contain or include any and/or all data, information, commercials, advertisement, marketing materials, surveys, questionnaires, focus group information, on-line focus group information, marketing research data or information, marketing programs, research, or plans, advertising programs, research, or plans, and/or any marketing and/or advertisement information obtained from, via, or a social network program or activity, and/or any social networking information relating or pertaining to or relating to marketing or advertising, and/or any other marketing data, information, or materials, stored at or in, or provided by, any of the marketing services computers 70 which are utilized by any of the marketing services providers, advertisers, or any providers of any goods, products, or services, and/or any other users of any the marketing services computers 70 utilized in connection with the apparatus 100 of the present invention. The database 10H can also contain or include television, radio, Internet, and/or video and audio, commercials, infomercials, video advertisements, video clips, audio advertisements, audio clips, banner advertisements, button advertisements, advertisements which can be placed on web pages and/or on frames surrounding viewed or viewable content, logos, icons, and/or any other information which can be utilized as an advertisement or commercial. The marketing materials can include surveys, questionnaires, and/or any other materials, which can be utilized in performing marketing research, market research, marketing planning and strategic planning, and/or any other information which can be used for gathering marketing information.

The database 10H can also contain or include any data and/or information regarding the effectiveness or any advertisements, marketing programs, research, or plans, advertising programs, research, or plans, and/or any marketing and/or advertisement or advertising information. The database 10H can contain or include any and/or all data and/or information which can be stored at or in, or provided by, any and/or all of the marketing services computers 70 which are utilized in connection with the present invention.

The database 10H can also contain or include information regarding any social networks which participate in the utilization of the apparatus 100, including, but not limited to, for each social network, data and/or information regarding the social networking computer(s) 80 utilized by the social network, information regarding each of the individuals, members, or subscribers, who belong to or who utilize the social network, as well as their names and addresses, their e-mail addresses, their test messaging numbers or information, their hobbies, their likes and/or dislikes, their education levels, their schools, jobs, employers, or occupations, their friends or followers, their social networking groups, and/or any other data and/or information regarding the individuals, members, or subscribers, of or to the social network serviced by the respective social networking computer 80. The database 10H can also contain or include any and/or all data and/or information stored in any and/or all of the social networking computers 80 which are utilized in connection with the apparatus 100 of the present invention.

The database 10H can also contain and/or include, for each individual, user, member, or subscriber, who or which utilize the apparatus 100 and method of the present invention, information regarding each personal communication device 90 or each of any number of personal communication devices 90 used by or associated with each individual, user, member, or subscriber. The database 10H can also include or contain information regarding each television, monitor, or entertainment device 95 used by or associated with each individual, user, member, or subscriber, and/or information regarding the types or kinds of televisions, monitors, or entertainment devices 95 which can be utilized by each individual, user, member, or subscriber, and/or information regarding the types or kinds of televisions, monitors, or entertainment devices 95 which can be utilized with, or which are or can be compatible with, any of the personal communication devices 90 associated with or used by each individual, user, member, or subscriber.

The database 10H can also include or contain data and/or regarding time zones associated with each personal entertainment account, information regarding any and/or all entertainment content provided in, or available in, each time zone. The database 10H can also include or contain data and/or information for enabling the central processing computer to calculate, determine, or ascertain, the position or location of any personal communication device 90 utilized in connection with the apparatus 100 of the present invention. The database 10H can also include or contain data and/or information for determining the position or location of any of any personal communication device 90 utilized in connection with the apparatus 100 of the present invention by “pinging” same.

The database 10H can also contain or include any and/or all data and/or information and/or any software programs, routines, and/or software applications or “apps”, needed or desired for performing any and/or of the processing routines, functions, and/or functionality, described herein as being provided by or performed by the apparatus 100 of the present invention and/or by the central processing computer 10. The database 10H can also contain or include any and/or all data and/or information and/or any software programs, routines, and/or software applications or “apps”, needed or desired for performing any and/or of the processing routines, functions, and/or functionality, described herein as being provided by the personal communication device 90, which such data and/or information and/or software applications or “apps”, being downloadable to the personal communication device 90 if and when needed or desired.

In a preferred embodiment, the database 10H can also contain or include any data and/or information needed or desired for performing any and all of the processing routines, functions, and/or functionality, described herein as being performed by the apparatus 100, and/or the central processing computer 10, and/or any of the other systems 20, 30, 40 and/or 50, and/or any of the computers 60, 70, and/or 80, described herein as being utilized in connection with the apparatus 100 of the present invention.

The central processing computer 10 also includes an output device 101, which is also connected to the CPU 10A, for outputting any data and/or information, described herein. In the preferred embodiment, the output device 101 can be a printer, a display, a transmitter, a modem, and/or any other device which can be used to output data or information.

The central processing computer 10 can also include a digital video/audio recording system 10J, such as for example, but not limited to, a digital video recorder (DVR) or a digital audio recorder, which is connected with or linked with the CPU 10A and which can record and store any of the content, channels, television channels, programming channels, shows, movies, programs, broadcasts, music, news shows or programs, and/or games or gaming content, and/or any other content and/or any information provided via the apparatus 100 of the present invention for or on behalf of any individual, user, member, or entity so that same can be viewed or listened to at a later time. In a preferred embodiment, the digital video/audio recording system 10 can record and store, for later viewing, any of the content, channels, television channels, programming channels, shows, movies, programs, broadcasts, news shows or programs, and/or games or gaming content, and/or any other content and/or any information, for any number of individuals, users, members, or entities, who or which utilize the apparatus 100 and methods of the present invention.

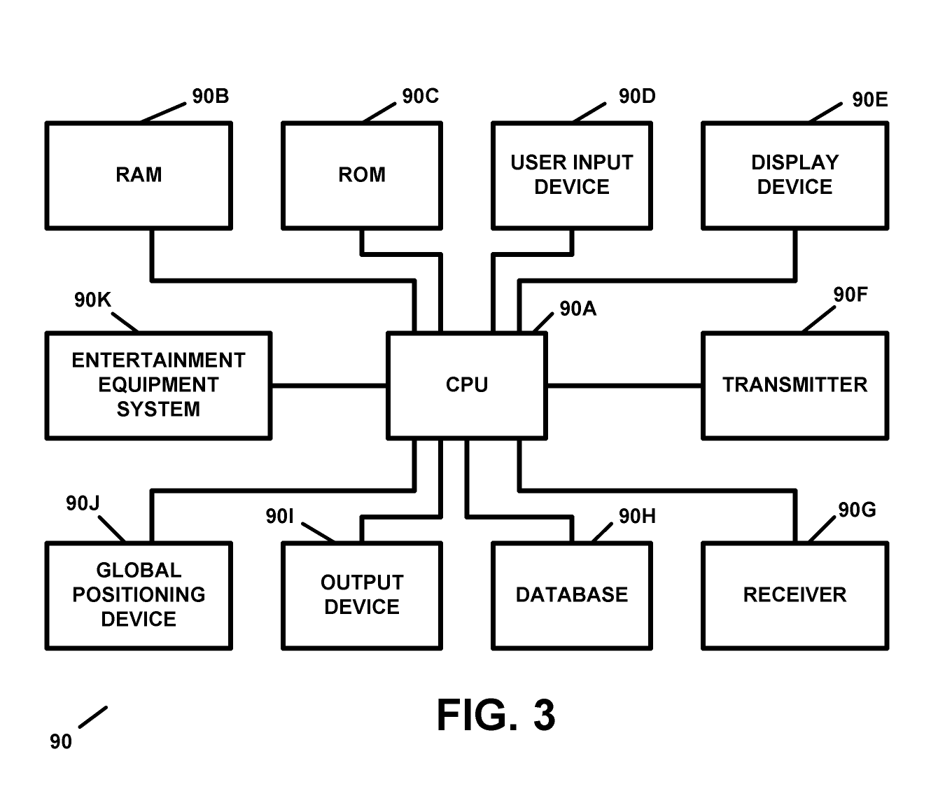

FIG. 3 illustrates the personal communication device 90 of FIG. 1, in block diagram form. With reference to FIG. 1, the personal communication device 90 includes a central processing unit or CPU 90A, which in the preferred embodiment, is a microprocessor. The CPU 90A may also be a microcomputer, a minicomputer, a macro-computer, and/or a mainframe computer, depending upon the application.

The personal communication device 90 also includes a random access memory device(s) 90B (RAM) and a read only memory device(s) 90C (ROM), each of which is connected to the CPU 90A, and a user input device 90D, for entering data and/or commands into the personal communication device 90, which includes any one or more of a keyboard, a scanner, a user pointing device, such as, for example, a mouse, a touch pad, a touch screen, and/or an audio input device and/or a video input device, a microphone or audio recording device, a camera or a video recording device, and/or any device, electronic and/or otherwise which can be utilized for inputting and/or entering data and/or information, of any kind or type pertinent to the operation of the apparatus 100 of the present invention, into the personal communication device 90. The input device 90D can also be any other input device(s) which are or can be utilized with or in connection with any of the personal communication devices 90 described herein as being utilized in connection with the apparatus 100 of the present invention. The input devices 90D are also connected to or with, or linked to or with, the CPU 90A. The input device 90D can also include any hardware or connector for connecting or interfacing the personal communication device 90 with the docking/interface device 98. The personal communication device 90 also includes a display device 90E for displaying data and/or information to a user or operator.

The personal communication device 90 also includes a transmitter(s) 90F, for transmitting signals and/or data and/or information to any one or more of the central processing computer(s) 10, the television broadcasting/transmitting systems 20, the cable television broadcasting/transmitting systems 30, the satellite television broadcasting/transmitting systems 40, the content provider broadcasting/transmitting systems 50, the ratings computers 60, the marketing services computers 70, the social networking computer 80, any other personal communication devices 90, and/or to any of the televisions, monitors, and/or entertainment devices 95, described herein.

The personal communication device 90 also includes a receiver(s) 90G, for receiving signals and/or data and/or information from any one or more of the central processing computer(s) 10, the television broadcasting/transmitting systems 20, the cable television broadcasting/transmitting systems 30, the satellite television broadcasting/transmitting systems 40, the content provider broadcasting/transmitting systems 50, the ratings computers 60, the marketing services computers 70, the social networking computer 80, from any other personal communication devices 90, and/or from any of the televisions, monitors, and/or entertainment devices 95, described herein.

The personal communication device 90 also includes a database(s) 90H, which is also connected to or linked with the CPU 90A, which can contain any and/or all of the data and/or information needed for performing any and/or all of the functions and/or functionality described herein as being performed by the apparatus 100 and method of the present invention as well as any and/or all of the functions and/or functionality described herein as being performed by the personal communication device 90.

In a preferred embodiment, the database 90 contains or includes data and/or information regarding the individual(s), user(s), member(s), or other entity or entities, who or which utilize the personal communication device 90, including, but not limited to, his, her, or its, name, address, telephone number(s), cellular telephone number(s), wireless telephone number(s), personal communication device telephone number(s), e-mail address(es), text message number(s) or information, SMS message(s) or information, account information, account information regarding accounts of relatives or friends, gender, sex, demographic information, education information, information regarding the time zone of address on file in the respective individual's, user's, member's, or entity's, account or personal entertainment account, information regarding occupation (if applicable), information regarding schooling, hobby information, information regarding interests, likes, or dislikes, account information or personal entertainment account information regarding content, channels, television channels, programming channels, shows, movies, programs, broadcasts, music, news show or programs, and/or games or gaming content, and/or any other content and/or any information regarding any television stations, cable television companies, satellite television stations, content providers, or any other provider of any content or services which provide same.

The database 90H can also include or contain, for each individual, user, member, or subscriber, information regarding that respective individual's, user's, member's, or subscriber's, personal entertainment account, which can include any and/or all of the television stations, cable television companies, satellite television stations, content providers, radio stations, or any other provider of any content or services, or any channel(s), television channel(s), programming channel(s), show(s), program(s), broadcast(s), or any other content, of same, or any channel(s), television channel(s), programming channel(s), show(s), program(s), broadcast(s), or any other content, selected by or subscribed to by the respective individual, user, member, or subscriber, or which are or may be otherwise included in the respective individual's, user's, member's, or subscriber's, personal entertainment account. The database 90H can also contain or include any link, links, hyperlink, or hyperlinks, to any and/or all of the television stations, cable television companies, satellite television stations, content providers, radio stations, or any other provider of any content or services, or any channel(s), television channel(s), programming channel(s), show(s), program(s), broadcast(s), or any other content, of same, or any channel(s), television channel(s), programming channel(s), show(s), program(s), broadcast(s), or any other content, selected by or subscribed to by the respective individual, user, member, or subscriber, or which are or may be otherwise included in the respective individual's, user's, member's, or subscriber's, personal entertainment account.

The database 90H can also contain or include any data and/or information regarding the individual's, user's, member's, or entity's personal communication device(s) 95 and any entertainment devices 95 which can be, or which are to be or might be, used in connection with the individual's, user's, member's, or entity's, account or personal communication device 90. The database 90H can also contain or include any data and/or information regarding an individual's, user's, member's, or entity's, content requests, content scheduling requests, travelling schedules, trip schedules, and/or any other data and/or information. The database 90H can also contain or include any data and/or information regarding an individual's, user's, member's, or entity's, request to record content, channels, television channels, programming channels, shows, movies, programs, broadcasts, channels, music, news shows or programs, and/or games or gaming content, and/or any other content and/or any information, for later viewing or listening. The database 90H can also contain or include any data and/or information regarding an individual's, user's, member's, or entity's, viewing habits or listening habits.

The database 90H can also contain or include information regarding an individual's, user's, members, or entity's, credit card, debit card, charge card, bank account, ATM account, savings account, checking account, brokerage account, electronic money account, any other payment account or any on-line payment account or mechanism, and/or any other pertinent financial information regarding accounts which any of the herein-described individuals, users, members, or entities, might use in conducting financial transactions.

The database 90H can also contain or include, for each television station, television broadcasting company or entity, radio station, radio broadcasting company or entity, a news organization, an educational entity, a gaming or game provider, cable television company, entity, or provider, satellite television company, entity, or provider, or any content provider of any type or kind, which or who utilize the apparatus 100 and method of the present invention, data and/or information regarding the content, channels, television channels, programming channels, shows, movies, programs, music, educational materials, and/or games, provided by same, the schedules of same, the programming schedule(s) for or corresponding to each television station, television broadcasting company or entity, radio station, radio broadcasting company or entity, a news organization, an educational entity, a gaming or game provider, cable television company, entity, or provider, satellite television company, entity, or provider, or any content provider, a link, links, hyperlink, or hyperlinks, to the content, channels, television channels, programming channels, shows, movies, programs, music, educational materials, and/or games, provided by same, the schedules of same, the programming schedule(s) for or corresponding to each television station, television broadcasting company or entity, radio station, radio broadcasting company or entity, a news organization, an educational entity, a gaming or game provider, cable television company, entity, or provider, satellite television company, entity, or provider, or any content provider, and information regarding each content, channel, television channel, programming channel, show, program, educational material, game, cast members, performers, participants or employees involved in same, newscasters, actors, actresses, screen writers, producers, sponsors, advertisers, promoters, ratings, ratings information, product placement information, and/or any other data and/or information regarding same.

The database 90H can also contain or include, for each television station, television broadcasting company or entity, radio station, radio broadcasting company or entity, a news organization, an educational entity, a gaming or game provider, cable television company, entity, or provider, satellite television company, entity, or provider, or any content provider of any type or kind, which or who utilize the apparatus 100 and method of the present invention, recordings of content, channels, television channels, programming channels, shows, movies, programs, music, educational materials, and/or games, provided by same, the schedules of same, the programming schedule(s) for or corresponding to each television station, television broadcasting company or entity, radio station, radio broadcasting company or entity, a news organization, an educational entity, a gaming or game provider, cable television company, entity, or provider, satellite television company, entity, or provider, or any content provider, as well as link, links, hyperlink, or hyperlinks, to any recorded content, channels, television channels, programming channels, shows, movies, programs, music, educational materials, and/or games, provided by same, the schedules of same, and the programming schedule(s) for or corresponding to each television station, television broadcasting company or entity, radio station, radio broadcasting company or entity, a news organization, an educational entity, a gaming or game provider, cable television company, entity, or provider, satellite television company, entity, or provider, or any content provider, and recordings of, or stored information regarding, same.

The database 90H can also contain or include any and/or all data and/or information regarding, and/or which can be stored in any databases or memory devices in or associated with, any of the central processing computer(s) 10, the television broadcasting/transmitting systems 20, cable television broadcasting/transmitting systems 30, satellite television broadcasting/transmitting systems 40, content provider broadcasting/transmitting systems 50, of, associated with, or utilized by, any of the television stations, television broadcasting companies or entities, radio stations, radio broadcasting companies or entities, news organizations, educational entities, gaming or game providers, cable television companies, entities, or providers, satellite television companies, entities, or providers, or any content providers of any type or kind, which or who utilize the apparatus 100 and method of the present invention, including, but limited to, any and/or all content, channels, television channels, programming channels, shows, movies, programs, music, educational materials, and/or games, provided by same, the schedules of same, the programming schedule(s) of same, and information regarding each content, channel, television channel, programming channel, show, program, educational material, game, and cast members, performers, participants or employees involved in same, newscasters, actors, actresses, screen writers, producers, sponsors, advertisers, promoters, ratings, ratings information, product placement information, and/or any other data and/or information regarding same.

In a preferred embodiment, any and/or all data and/or information stored in, utilized by or at, or provided by any of, the central processing computer(s) 10, the television broadcasting/transmitting systems 20, cable television broadcasting/transmitting systems 30, satellite television broadcasting/transmitting systems 40, content provider broadcasting/transmitting systems 50, of, associated with, or utilized by, any of the television stations, television broadcasting companies or entities, radio stations, radio broadcasting companies or entities, news organizations, educational entities, gaming or game providers, cable television companies, entities, or providers, satellite television companies, entities, or providers, or any content providers of any type or kind, which or who utilize the apparatus 100 and method of the present invention, including any and/or all content, channels, television channels, programming channels, shows, movies, programs, music, educational materials, and/or games, provider by or from same, can also be stored in the database 90H and/or in or at any other memory devices or storage devices of or associated with the personal communication device 90.

The database 90H can also contain or include any and/or all data and/or information pertaining to utilizing and/or providing any of the herein-described data, information, any of the any and/or all content, channels, television channels, programming channels, shows, movies, programs, music, educational materials, and/or games, described herein as being provided by or via the apparatus 100.

The database 90H can also contain or include time zone information associated with the individual's, user's, member's, or subscriber's, personal entertainment account, as well the time zones for all of the television stations, television broadcasting companies or entities, radio stations, radio broadcasting companies or entities, news organizations, educational entities, gaming or game providers, cable television companies, entities, or providers, satellite television companies, entities, or providers, or any content providers of any type or kind, which or who utilize the apparatus 100 and method of the present invention, as well as any other data and/or information needed or desired for performing of the functions and functionality described herein regarding any providing of any and/or all content, channels, television channels, programming channels, shows, movies, programs, music, educational materials, and/or games, to an individual, user, member, or subscriber who may be located or situated in a time zone, which may be different time zone from a time zone in which a television station, television broadcasting company or entity, radio station, radio broadcasting company or entity, news organization, educational entity, gaming or game provider, cable television company, entity, or provider, satellite television company, entity, or provider, or any other content provider, is located or situated.

The database 90H can also contain or include, for each and every ratings service organization, or for each and/or every ratings company, business, entity, or individual which or who utilizes a ratings computer 60, any data and/or information stored in or at each respective ratings computer 60, any data and/or information used by each respective ratings computer 60, and/or any and/or all data and/or information, stored at or in, or provided by, each respective ratings computer 60, information regarding various ratings, viewership information, listenership information, and/or usership information, for any of the various content, channels, television channels, programming channels, shows, movies, programs, music, educational materials, and/or games, described herein as being provided by or via the apparatus 100, as well as any ratings information regarding advertisements, commercials, and/or marketing information, which can also be provided by the apparatus 100 of the present invention.

The database 90H can also contain or include ratings information regarding actors, actress, performers, celebrities, and any other individuals or participants of any of the channels, television channels, programming channels, shows, movies, various content, shows, programs, music, educational materials, and/or games, described herein as being provided by or via the apparatus 100. For example, ratings information for an actor or actress, an athlete, a news reporter or television personality, a musician, a singer, or any other individual appearing in or associated with any of the channels, television channels, programming channels, shows, movies, various content, shows, movies, programs, music, educational materials, and/or games, described herein as being provided by or via the apparatus 100, can also be stored in the database 90H.

The database 90H can also contain or include ratings information regarding any goods, products, or services, which may appear in, or which may be associated with any advertisements or sponsors of, any of the channels, television channels, programming channels, shows, movies, various content, shows, movies, programs, music, educational materials, and/or games, described herein as being provided by or via the apparatus 100. For example, ratings information for a good, a products or a services which might be placed in or identified in, or appear in an advertisement during or in, any of the channels, television channels, programming channels, shows, movies, various content, shows, movies, programs, music, educational materials, and/or games, described herein as being provided by or via the apparatus 100, can also be stored in the database 90H.

The database 90H can also contain or include any and/or all data, information, commercials, advertisement, marketing materials, surveys, questionnaires, focus group information, on-line focus group information, marketing research data or information, marketing programs, research, or plans, advertising programs, research, or plans, and/or any marketing and/or advertisement information obtained from, via, or a social network program or activity, and/or any social networking information relating or pertaining to or relating to marketing or advertising, and/or any other marketing data, information, or materials, stored at or in, or provided by, any of the marketing services computers 70 which are utilized by any of the marketing services providers, advertisers, or any providers of any goods, products, or services, and/or any other users of any the marketing services computers 70 utilized in connection with the apparatus 100 of the present invention. The database 90H can also contain or include television, radio, Internet, and/or video and audio, commercials, infomercials, video advertisements, video clips, audio advertisements, audio clips, banner advertisements, button advertisements, advertisements which can be placed on web pages and/or on frames surrounding viewed or viewable content, logos, icons, and/or any other information which can be utilized as an advertisement or commercial. The marketing materials can include surveys, questionnaires, and/or any other materials, which can be utilized in performing marketing research, market research, marketing planning and strategic planning, and/or any other information which can be used for gathering marketing information.

The database 90H can also contain or include any data and/or information regarding the effectiveness or any advertisements, marketing programs, research, or plans, advertising programs, research, or plans, and/or any marketing and/or advertisement or advertising information. The database 90H can contain or include any and/or all data and/or information which can be stored at or in, or provided by, any and/or all of the marketing services computers 70 which are utilized in connection with the present invention.

The database 90H can also contain or include information regarding any social networks which participate in the utilization of the apparatus 100, including, but not limited to, for each social network, data and/or information regarding the social networking computer(s) 80 utilized by the social network, information regarding each of the individuals, members, or subscribers, who belong to or who utilize the social network, as well as their names and addresses, their e-mail addresses, their test messaging numbers or information, their hobbies, their likes and/or dislikes, their education levels, their schools, jobs, employers, or occupations, their friends or followers, their social networking groups, and/or any other data and/or information regarding the individuals, members, or subscribers, of or to the social network serviced by the respective social networking computer 80.

The database 90H can also contain or include any and/or all data and/or information stored in any and/or all of the social networking computers 80 which are utilized in connection with the apparatus 100 of the present invention.

The database 90H can also contain and/or include, for the respective individual, user, member, or subscriber, to who the personal communication device 90 is associated or who uses same, information regarding each personal communication device 90 or each of any number of personal communication devices 90 used by or associated with the respective individual, user, member, or subscriber. The database 90H can also include or contain information regarding each television, monitor, or entertainment device 95 used by or associated with the respective individual, user, member, or subscriber, and/or information regarding the types or kinds of televisions, monitors, or entertainment devices 95 which can be utilized by the respective individual, user, member, or subscriber, and/or information regarding the types or kinds of televisions, monitors, or entertainment devices 95 which can be utilized with, or which are or can be compatible with, the particular personal communication device 90 or any other personal communication devices associated with or used by the respective individual, user, member, or subscriber.

In a preferred embodiment, the database 90H can also contain or include any data and/or information needed or desired for performing any and all of the processing routines, functions, and/or functionality, described herein as being performed by the personal communication device 90 and/or the apparatus 100 of the present invention.

The personal communication device 90 also includes an output device 101, which is also connected to the CPU 90A, for outputting any data and/or information, described herein. In the preferred embodiment, the output device 901 can be a printer, a display, a transmitter, a modem, and/or any other device which can be used to output data or information. The input device 901 can also include any hardware or connector for connecting or interfacing the personal communication device 90 with the docking/interface device 98.

The personal communication device 90 can also be equipped with a global positioning device 901 which can be connected to the CPU 90A and which can be utilized to calculate, determine, or ascertain, the position or location of the personal communication device 90.

The personal communication device 90 can also include entertainment equipment system 90K which is also connected to the CPU 90A. The entertainment equipment system 90K can contain or include hardware, software, firmware, or any other technology or equipment typically found in or included in a television set-top box, a personal cable television box, a personal satellite television box, a personal gaming device or box, a gaming console, or any other personal entertainment center, device, or hub. The include entertainment equipment system 90K, in the preferred embodiment, can also contain or include a digital video recorder (DVR) or a digital audio recorder, a digital video recording system or equipment, a digital audio recording system or equipment, or any another digital video and audio recording device or equipment, or any other digital media recoding equipment or device, that can allow the personal communication device 90 to record and store, for later play-back, any of the content or entertainment content described herein as being provided by or via the apparatus 100 of the present invention.

The digital video recorder (DVR) or digital audio recorder, digital video recording system or equipment, digital audio recording system or equipment, or other digital video and audio recording device or equipment, or any other digital media recoding equipment or device, can record and store, for later play-back, any of the content, channels, television channels, programming channels, shows, movies, programs, broadcasts, music, news shows or programs, and/or games or gaming content, and/or any other content and/or any information provided via the apparatus 100 of the present invention for or on behalf of the individual, user, member, or subscriber, or entity, so that same can be viewed or listened to at a later time and from any location. In a preferred embodiment, the digital video recorder (DVR) or digital audio recorder, digital video recording system or equipment, digital audio recording system or equipment, or other digital video and audio recording device or equipment, or any other digital media recoding equipment or device, can record and store, for later viewing or play-back, any of the content, channels, television channels, programming channels, shows, movies, programs, broadcasts, news shows or programs, and/or games or gaming content, and/or any other content and/or any information, for the respective individual, user, members, or subscriber, or entity, who or which utilize the apparatus 100 and methods of the present invention.

In a preferred embodiment, the apparatus 100 of the present invention can be utilized in order to allow any individual, user, member, subscriber, or entity (hereinafter “user”) to create, establish, or set-up, a customized and/or personal television and/or entertainment account (hereinafter “personal entertainment account”). In a preferred embodiment, the personal entertainment account can be created, established, or set-up, by the user, and/or can be customized by the user so that it can include and provide the user with any of the channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, described herein as being provided by the apparatus 100 of the present invention. The user can select any of the channel(s), television channel(s), programming channel(s), shows, movies, programs, news programs or shows, television programs or shows, radio programs or shows, informational programs or shows, entertainment programs or shows, sporting and/or athletic programs or shows, movies, educational programs or courses, advertisements, commercials, and/or marketing information, described herein as being provided by the apparatus 100 of the present invention for inclusion in his or her personal entertainment account.

In a preferred embodiment, the personal entertainment account can include channel(s), television channel(s), programming channel(s), shows, movies, programs, news programs or shows, television programs or shows, radio programs or shows, informational programs or shows, entertainment programs or shows, sporting and/or athletic programs or shows, or educational programs or courses (hereinafter referred to as (“entertainment content”), and/or advertisements, commercials, and/or marketing information (hereinafter also referred to as “entertainment content”), which can be provided by any number of the herein-described television stations, cable television companies or service providers, satellite television companies or service providers, other television companies or service providers, content providers, radio stations, education institutions, game or gaming providers, or any other companies, service providers, or any other providers of any kind or type of content which can be suitable or desirable for providing via a personal entertainment account (hereinafter also referred to as “content providers” or each in the singular also referred to as “content provider”). In this regard, the personal entertainment account, in a preferred embodiment, can be created, established, or set-up, to include and/or provide entertainment content from any number or a plurality of content providers. In another preferred embodiment, the personal entertainment account can also be set up or established to include or entertainment content from a single content provider if so desired.

In a preferred embodiment, the personal entertainment account can be assigned to, can be personal to, can correspond to, or can be used by, a single user. In another preferred embodiment, the personal entertainment account can be assigned to, can be personal to, or can correspond to, or can be used by, multiple users. In a preferred embodiment, a personal communication device 90, or any number of personal communication devices 90, can be associated with any personal entertainment account. In another preferred embodiment, a personal communication device 90, or any number of personal communication devices 90, can also be associated with any number or personal entertainment accounts.

In another preferred embodiment, the personal entertainment account can also be established from a household's or other entity's cable television service provider account or package, satellite television service provider account or package, or other television service provider account or package.

In a preferred embodiment, the personal entertainment account can be customized by the user. In another preferred embodiment, the user can make changes to the content included in or provided by his or her personal entertainment account at any time or “on-the-fly”, with any such changes becoming effective immediately or at any other time.

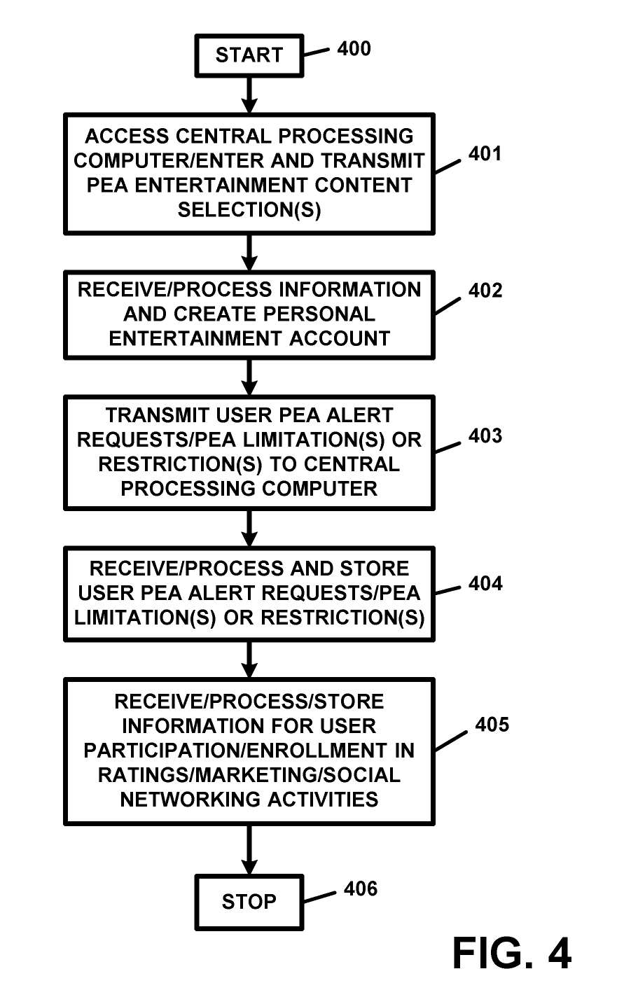

FIG. 4 illustrates a preferred embodiment method of utilizing the apparatus 100 and method of the present invention, in flow diagram form. FIG. 4 illustrates a preferred embodiment method for creating, establishing, or setting-up, a personal entertainment account, in flow diagram form. With reference to FIG. 4, the operation of the apparatus 100 commences at step 400. At step 401, a user desiring to create, establish, or set-up, a personal entertainment account can access the central processing computer 10 with or using any one of the herein-described personal communication devices 90 or any other personal computer, laptop computer, notebook computer, tablet computer, tablet, cellular telephone, personal digital assistant, smart phone, wireless telephone or communication device, cellular communication device, mobile communication device, or any other suitable communication device or other device.

At step 401, the user can select the entertainment content which he or she desires to be included in his or her personal entertainment account. The user can select from any of the various channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information which can be provided by any number of the herein-described content providers including, but not limited to, television stations, cable television companies or service providers, satellite television companies or service providers, other television companies or service providers, content providers, radio stations, education institutions, game or gaming providers, or any other companies, service providers, or any other providers of any kind or type of content which can be suitable or desirable for providing via a personal entertainment account.

In a preferred embodiment, the user can select, for inclusion in the entertainment content in his or her personal entertainment account, any number, type, or kind, of channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information which can be provided by any number of the herein-described content providers including, but not limited to, television stations, cable television companies or service providers, satellite television companies or service providers, other television companies or service providers, content providers, radio stations, education institutions, game or gaming providers, or any other companies, service providers, or any other providers of any kind or type of content.

In a preferred embodiment, the user can select, for inclusion in the entertainment content in his or her personal entertainment account, any number, type, or kind, of channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, provided by one or more of, and/or by each of, and/or by any number of, the herein-described television broadcasting/transmitting systems 20, cable television broadcasting/transmitting systems 30, satellite television broadcasting/transmitting systems 40, and/or content provider broadcasting/transmitting systems 50 (hereinafter referred to in the plural as “entertainment content providers” and in the singular as an “entertainment content provider”). In a preferred embodiment, the user's personal entertainment account can include entertainment content from more than one broadcaster, transmitter, or provider, of entertainment content or from more than one entertainment content provider. In this manner, the personal entertainment account can be customized to include entertainment content provided from a plurality of entertainment content providers and/or from different and/or separate entertainment content providers. In a preferred embodiment, the personal entertainment account can be customized to include entertainment content provided from a plurality of, and/or from different and/or separate, entertainment content providers, and/or from any number of, or any plurality of, and/or any combination of, and/or from different and/or separate, television broadcasting/transmitting systems 20, cable television broadcasting/transmitting systems 30, satellite television broadcasting/transmitting systems 40, and/or content provider broadcasting/transmitting systems 50.

The user can, in one exemplary embodiment, select entertainment content from a television broadcasting/transmitting system(s) 20, from a cable television broadcasting/transmitting system(s) 30, from a satellite television broadcasting/transmitting system(s) 40, and from a content provider broadcasting/transmitting system(s) 50, or the user can select entertainment content from two or more television broadcasting/transmitting systems 20, from two or more cable television broadcasting/transmitting systems 30, from two or more satellite television broadcasting/transmitting systems 40, or from two or more content provider broadcasting/transmitting systems 50, for inclusion in his or her personal entertainment account.

In a preferred embodiment, the central processing computer 10 can provide menus and other information regarding available entertainment content from which the user can make his or her various entertainment content selections. In another preferred embodiment, any menus or information can also be provided on or by an entertainment content basis, on or by a content provider basis, or on or by any other information basis. In a preferred embodiment, any information or menus provided by the central processing computer 10 can be transmitted to the user's personal communication device 90 at step 401.

In another preferred embodiment, the number, type, or kind of entertainment content, channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, which can be provided by any number of the herein-described content providers including, but not limited to, television stations, cable television companies or service providers, satellite television companies or service providers, other television companies or service providers, content providers, radio stations, education institutions, game or gaming providers, or any other companies, service providers, or any other providers of any kind or type of content, can also be limited by or governed by service packages offerings and/or service pricing packages or offerings.

At step 401, the user can select of the herein-described entertainment content which is to be included in and/or provided by and/or in the user's personal entertainment account. At step 402, the central processing computer can receive and process the information regarding the entertainment content selected by the user and can process information to creating or establishing the user's personal entertainment account. At step 402, the central processing computer 10 can establish or create the user's personal entertainment account and store any and/or all information regarding same.

In a preferred embodiment, a television channel or a television channel number can be assigned to each channel, television channel, programming channel, entertainment content, show, program, news program or show, television program or show, radio program or show, informational program or show, entertainment program or show, sporting and/or athletic program or show, educational program or course, selected by the user to be included in his or her personal entertainment account. In a preferred embodiment, a television channel or a television channel number can also be assigned for advertisements, commercials, or marketing information, selected to be included in his or her personal entertainment account.

In a preferred embodiment, the television channels or channel numbers can be assigned automatically by the central processing computer and the user can be provided with a television channel menu or line-up which can be stored in the personal entertainment account and which can be accessed by the user at any time. In another preferred embodiment, the user can assign the channels or channel numbers upon creating or establishing the personal entertainment account and the central processing computer 10 can automatically generate the television channel menu or line-up which can also be stored in the personal entertainment account and which can be accessed by the user at any time.

At step 403, the central processing computer 10 can also provide the user with the opportunity, including any necessary or desired information or menus, to request user-defined alerts from the central processing computer 10, as well as with the opportunity, including any necessary or desired information or menus, to place or define limitations or restrictions on or regarding any use or activity regarding the personal entertainment account.

In a preferred embodiment, the user can request to receive an alert when certain entertainment content is or will become available via the apparatus 100 and/or the personal entertainment account, when certain entertainment content may cease from being available via the apparatus 100 and/or the personal entertainment account, when entertainment content involving or starring certain actors, actresses, performers, celebrities, television personalities, or radio or other personalities, is or may become available via the apparatus 100 and/or the personal entertainment account, and/or when certain athletic or sports events, news events, or any other of the herein-described content, channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, is or will become available via the apparatus 100 and/or the personal entertainment account. Alerts can also be request to alert or inform the user when payments for personal account service are due and can include account statement or activity statement, when payments have been received and/or to provide any other information to the user regarding his or her personal entertainment account.

In a preferred embodiment, the limitations or restrictions can include, but are not limited to types or kinds of entertainment content which is allowed to be included in or accessible via the personal entertainment account, types or kinds of entertainment content which is disallowed from being included in or which is not allowed to be accessible via the personal entertainment account, allowed times and/or days of use, disallowed times and/or days of use, allowed time limits for use of the personal entertainment account in a single use session and/or for a pre-determined time period, allowed spending amounts in electronic commerce transactions or other transactions on or via the personal entertainment account or in transactions processed by the apparatus 100, allowed spending limits for or regarding the personal entertainment account, limits or restrictions on additional entertainment content and/or additional services which may be added to the personal entertainment account, limits or restrictions on additional entertainment content and/or additional services which may be deleted or cancelled from the personal entertainment account, limitations or restrictions regarding roaming use, or away from home use, of the personal entertainment account, and/or any limitations or restrictions on, regarding, or involving, use of the personal entertainment account.

In a preferred embodiment, a limitation or restriction can also be used to limit or restrict any authorized use or activity on, involving, or regarding, the personal entertainment account, and/or a limitation or restriction can also be used to prevent or to prohibit any unauthorized use or activity regarding the personal entertainment account.

In a preferred embodiment, and of the herein-described limitations or restrictions can also be programmed into any one or more of any personal communication devices 90 used in connection with, or associated with, any personal entertainment account.

At step 403, the user can enter via the personal communication device 90, and transmit to the central processing computer 10, any information regarding any requested or desired alerts requested and/or any limitations or restrictions which are to be place on or regarding the personal entertainment account. At step 404, the central processing computer 10 will receive and process any information received regarding any alerts and/or any limitations or restrictions and store said information in the personal entertainment account.

At step 405, the central processing computer 10 can also provide the user with information for allowing the user to enroll in, and/or to participate in, ratings activities or ratings-related activities offered by any of the herein-described ratings reporting services or entities, or any company, entity, business, or individual, which or who provides any services, information, or products, pertaining to ratings or ratings information. In a preferred embodiment, the user can receive monetary and/or non-monetary for participating in ratings activities or ratings-related activities. In a preferred embodiment, can payments made to the user can also be paid, whether monetary and/or non-monetary, into the user's personal entertainment account. At step 405, the user can enroll in any ratings activities transmitting any needed or desired information to the central processing computer 10. At step 405, the central processing computer 10 can receive and process any of the above-described information entered by the user and store same in the user's personal entertainment account.

At step 405, the central processing computer 10 can also provide the user with information for allowing the user to enroll in, and/or to participate in, marketing activities or marketing-related activities offered by any the herein-described companies, entities, businesses, or individuals, which or who provide any marketing services or products, advertising services or products, marketing strategy services or products, and/or any provider of any goods, products, or services. In a preferred embodiment, the user can also receive monetary and/or non-monetary for participating in any marketing activities or marketing-related activities. In a preferred embodiment, can payments made to the user can also be paid, whether monetary and/or non-monetary, into the user's personal entertainment account. Examples of non-monetary compensation can include, but not be limited to, goods, products, services, or coupons or discount offers for same. At step 405, the user can enroll in any marketing activities or marketing-related activities by entering, and by transmitting to the central processing computer 10, any needed or desired information. At step 405, the central processing computer 10 can receive and process any of the above-described information entered by the user and store same in the user's personal entertainment account.

At step 405, the central processing computer 10 can also provide the user with information for allowing the user to enroll in, and/or to participate in, any social network(s) or in social networking activities with any available social network or social networks, or to enter information regarding any existing social networks to which they belong. At step 405, the central processing computer 10 can receive and process any of the above-described information entered by the user and store same in the user's personal entertainment account.

At step 405, the user can also register any personal communication devices 90 for use in connection with the personal entertainment account. At step 405, the user can also register any televisions, monitors, or entertainment devices 95 for use in connection with the personal entertainment account. At step 405, the central processing computer 10 can receive and process any of the above-described information entered by the user and store same in the user's personal entertainment account. Once all information has been processed and stored at step 405, the operation of the central processing computer 10 will cease at step 406.

In another preferred embodiment, the apparatus 100 of the present invention can be utilized in order to provide any of the herein-described entertainment content to any individual, user, member, or subscriber, having a personal entertainment account, or having access or use of a personal entertainment account and via the personal communication device 90 which can serve as a television set-top box, a personal cable television box, a personal satellite television box, a personal gaming device or box, a gaming console, or any other personal entertainment center, device, or hub. In this regard, the personal communication device 90, whether it be any one of a personal computer, a laptop computer, a notebook computer, a tablet computer, a cellular telephone, a personal digital assistant, a wireless telephone, a wireless communication device, a personal communication device, a personal communications services device, a smart phone, a mobile telephone, a hand-held device or computer, a palm-top device or computer, a watch, a telephone, a television, an interactive television, a digital television, a smart television or entertainment device, an internet-enabled television or entertainment device, or any other suitable device, can be utilized as a television set-top box, a personal cable television box, a personal satellite television box, a personal gaming device or box, a gaming console, or any other personal entertainment center, device, or hub.

Although the personal communication device 90 can be a personal computer, a laptop computer, a notebook computer, a tablet computer, a cellular telephone, a personal digital assistant, a wireless telephone, a wireless communication device, a personal communication device, a personal communications services device, a smart phone, a mobile telephone, a hand-held device or computer, a palm-top device or computer, a watch, a telephone, a television, an interactive television, a digital television, a smart television or entertainment device, an internet-enabled television or entertainment device, or any other suitable device, in a preferred embodiment wherein an individual, user, member, or subscriber, desires to have a personal entertainment account which can be accessed and used from anywhere in the World and/or at any time when travelling away from home, the personal communication device 90 can be a portable device such as a smart phone, a tablet computer, a laptop computer, a notebook computer, a cellular telephone, a personal digital assistant, a wireless telephone, a wireless communication device, personal communication device, a personal communications services device, a smart phone, a mobile telephone, a hand-held device or computer, a palm-top device or computer, or any other mobile or portable device.

In a preferred embodiment, the apparatus 100 of the present invention can be utilized in order to provide a respective individual, user, member, or subscriber, with his or her entertainment content made available in or from his or her personal entertainment account via a personal communication device 90 and/or via a personal entertainment device 90 used in connection with or along with an entertainment device 95. In a preferred embodiment, the respective individual, user, member, or subscriber, can access and utilize the apparatus 100, to access entertainment content while at home, while away from home, while travelling, while in a vehicle, or from anywhere in the World and/or with any available personal communication device 90 and/or entertainment device 95.

In this regard, the respective individual, user, member, or subscriber, can, for example, be provided with hometown or local news, television shows or programming, television channels, or any other selected, favorite, or normally watched or received, entertainment content, channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, while travelling or away from home.

In a preferred embodiment, an individual, user, member, or subscriber (hereinafter referred to a “user” for simplicity) can utilize the apparatus 100 in order to access, view, receive, or otherwise be provided with, his or her entertainment content available in his or her personal entertainment account via his or her personal communication device 90. In such a preferred embodiment, the personal communication device 90 can be utilized as a television set-top box, a personal cable television box, a personal satellite television box, a personal gaming device or box, a gaming console, or any other personal entertainment center, device, or hub, which can be connected to an entertainment device 95 which can be a television, a digital television, an interactive television, or a smart television. It is also important to note that, depending on the application, the entertainment device 95 can be any of the devices described herein as being an entertainment device 95.

In an exemplary preferred embodiment, the apparatus 100 of the present invention will be described as being utilized to access, view, receive, or otherwise be provided with, television content in an embodiment in which the personal communication device 95 is utilized as a television set-top box and in which a television is utilized as the entertainment device 95. It is important to note, however, that the apparatus 100 of the present invention can be utilized to provide any of the herein-described entertainment content via any personal communication device 90 described herein and/or via any personal communication device 90 described herein used in connection with or along with any entertainment device 95 described herein.

In a preferred embodiment, prior to use, the personal communication device 90 can be connected to the entertainment device 95. In the preferred embodiment, the personal communication device 90 can be connected to the entertainment device 95, which in the preferred embodiment is a television 95, such as by or with a connecting cable, a cable, a line, a wire, an HDMI cable, or any other appropriate cable, wire, or with an appropriate connector. In the preferred embodiment, the connection is made from the personal communication device 90 and, in particular from an output of the personal communication device 90, to an input, an input connection, a input port, or other input device, of the television 95, in a same, a similar, or an analogous, manner in which a television set-top box or cable television box is connected or “hooked-up” to a television. In this regard, the entertainment content output or output device of the personal communication device 90 is connected to, or linked with, the pertinent input or input device of the television 95.

In another preferred embodiment, the personal communication device 90 can be linked wirelessly to or with the television so that the output of the personal communication device 90 can be wirelessly linked with, or wirelessly “connected to”, the respective input, input connection, input port, or other input device, of the television 95. In a preferred embodiment, the personal communication device 90 and the television can be wirelessly linked using any appropriate wireless connection, wireless equipment or device, wireless modem, a Wi-Fi network or Wi-Fi equipment or device, a Bluetooth device or equipment, or any other wireless network and/or wireless connection or equipment or device.

In another preferred embodiment, wherein a docking/interface device 98 is utilized, the personal communication device 90 can be place in or on the docking/interface device 98 and either the personal communication device 90 can be directly connected to or directly linked with the television 95, or the personal communication device 90 can be connected to or linked with the television 95 via the docking/interface device 98.

In a preferred embodiment, the personal communication device 90 can also be pre-programmed to control any operation of the television 95, such as, but not limited to, channel selection, volume control, brightness, darkness, or contrast control, and input selection.

Once the personal communication device 90 is connected with, or linked with, the television 95 in any appropriate manner described above or otherwise, the user can then activate a “personal entertainment account” mode of operation of the personal communication device 90 and can view his or her entertainment content, available via his or her personal entertainment account, via the television 95, in a manner similar to or analogous to using a television set-top box to access television content. The user may switch channels, control volume, and control any other operation or setting of the television, such as, but not limited to, channel selection, volume control, brightness, darkness, or contrast control, and input selection, via the personal communication device 90.

In a preferred embodiment, any and/or all entertainment content provided by each of the herein-described television broadcasting/transmitting systems 20, cable television broadcasting/transmitting systems 30, satellite television broadcasting/transmitting systems 40, and content provider broadcasting/transmitting systems 50, can be continuously transmitted to or broadcast to the central processing computer 10 so that the central processing computer 10 can transmit or broadcast any and/or all entertainment content associated with or included in the user's personal entertainment account to the personal communication device 90.

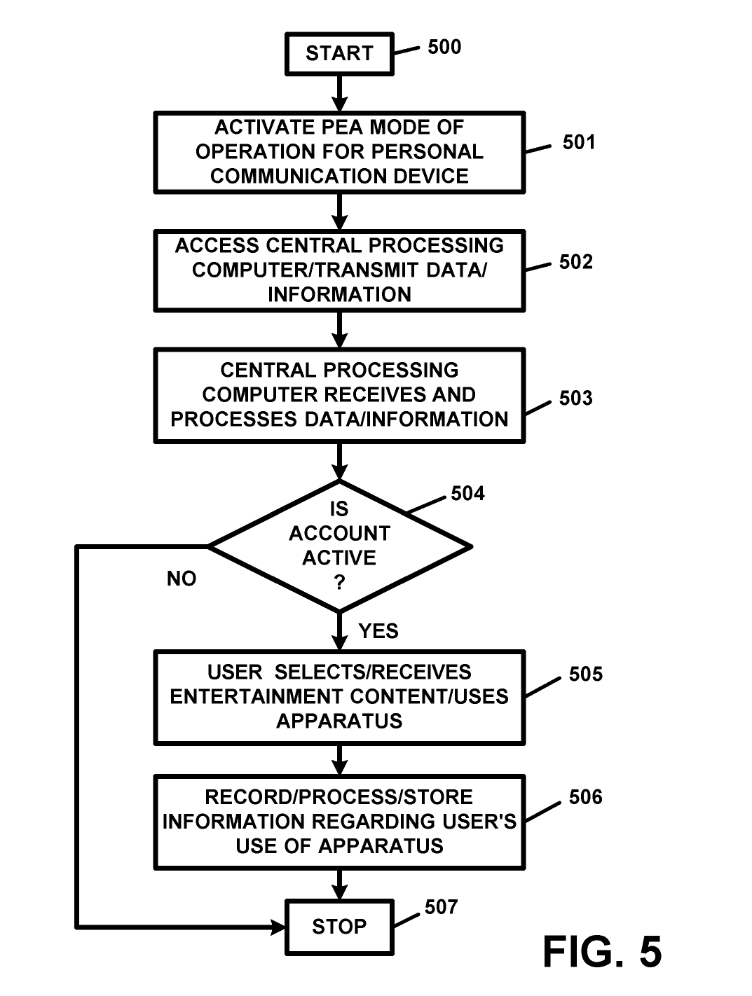

FIG. 5 illustrates a preferred embodiment method of utilizing the apparatus 100 and method of the present invention, in flow diagram from. After the personal communication device 90 has been connected to, or linked with the, television 95, so that the pertinent entertainment content output or output device of the personal communication device 90 is connected to, or linked with, the pertinent input or input device of the television 95, the apparatus 100 will be ready for operation or use. With reference to FIG. 1, the operation of the apparatus 100 commences at step 500.

At step 501, the user activates the “personal entertainment account” (“PEA”) mode of operation or operating mode of the personal communication device 90. In a preferred embodiment, the activation of the “personal entertainment account” mode of operation or operating mode, of the personal communication device 90, starts the operation of the personal communication device 90 in this “personal entertainment account” mode of operation. In a preferred embodiment, the “personal entertainment account” mode of operation and/or the personal communication device 90 can operate or can be run, and/or can be controlled, pursuant to software, a software application(s) or a software “app”(s), which can control the operation of the personal communication device 90 in this mode of operation.

At step 502, the personal communication device 90 can access the central processing computer 10 and can transmit data and/or information regarding the personal entertainment account associated with the user and/or with the personal communication device 90 to the central processing computer 10. The data and/or information can include, but need not be limited to, a personal entertainment account number and/or any other identifying information. At step 503, the central processing computer 10 will receive and process the data and/or information regarding the personal entertainment account. At step 504, the central processing computer 10 can determine if the personal entertainment account is active or in good standing so that it can be used. If, at step 504, the central processing computer 10 determines that the personal entertainment account is inactive or is not in good standing, then the central processing computer 10 can terminate the operation of the apparatus 10 at step 507. If at step 504, the central processing computer 10 determines that the personal entertainment account is active or in good standing, so that it can be used, then the operation of the apparatus 100 will proceed to step 505.

At step 505, the user can select any television channel or any other entertainment content in his or her personal entertainment account for viewing, listening, or for receiving, on or via the television 95. In a preferred embodiment, any and/or all entertainment content provided by each of the herein-described television broadcasting/transmitting systems 20, cable television broadcasting/transmitting systems 30, satellite television broadcasting/transmitting systems 40, and content provider broadcasting/transmitting systems 50, can be continuously transmitted to or broadcast to the central processing computer 10 so that the central processing computer 10 can transmit or broadcast any and/or all entertainment content associated with or included in the user's personal entertainment account to the personal communication device 90.

At step 505, the user's television channel selection can be transmitted to the central processing computer 10. In response to receiving the user's television channel selection, the central processing computer 10 will transmit or broadcast the entertainment content being provided on that television channel to the personal communication device 90 and the entertainment content will be provided to the user via the television 95.

In another preferred embodiment or in an alternate preferred embodiment, at step 505, any and/or all entertainment content provided by each of the herein-described television broadcasting/transmitting systems 20, cable television broadcasting/transmitting systems 30, satellite television broadcasting/transmitting systems 40, and content provider broadcasting/transmitting systems 50, can be continuously transmitted to or broadcast to the central processing computer 10 and the central processing computer 10 can, in turn, continuously transmit or broadcast any and/or all of the entertainment content associated with or included in all of the channels included in the user's personal entertainment account to the personal communication device 90. In this regard, in another preferred embodiment or alternate embodiment, the entertainment content being provided on the user selected television channel will be provided to the user via the television 95 without having to transmit any television channel selection to the central processing computer 10. In such an alternate preferred embodiment, all channels in the user's personal entertainment account are and/or will be available for selection at the personal communication device 90, thereby dispensing with any need to transmit any television channel selection to the central processing computer 10.

At step 505, the user can watch whichever channels he or she desires, can change channels, view commercials or advertisements, and/or utilize his or her personal entertainment account in any desired manner. When the user is finished using his or her personal entertainment account he or she can simply de-activate or exit the “personal entertainment account” mode of operation of the personal communication device 10 at step 506. At step 506, the central processing computer 10 can record, process, and/or store, any information regarding the user's use of the personal entertainment account. Thereafter, the operation of the apparatus 100 will cease at step 507.

In another preferred embodiment, the apparatus 100 of the present invention can be utilized without the television 95 or entertainment device 95. In this preferred embodiment, any and/or all entertainment content can be provided to the user via the personal communication device 90.

In another preferred embodiment, the user, at step 505, can make changes to his or her personal entertainment account, add any of the herein-described entertainment content or channels to his or her personal entertainment account, delete any of the of the herein-described entertainment content or channels from his or her personal entertainment account, and/or make any other changes, set or establish criteria for receiving alerts or alert messages, place limitations or restrictions on the use of his or her personal entertainment account, and/or perform any other activity regarding same. At step 505 and/or at step 506, the central processing computer 10 can receive, process, and/or store, any information regarding any changes made by the user.

In another preferred embodiment, the user can, at step 505, access ratings information by ether requesting same from the central processing computer 10 and/or by accessing and requesting same from the ratings computer(s) 60. In another preferred embodiment, a user can, at step 505, also request to receive ratings reports regarding any of the herein-described entertainment content provided by any of the herein-described television broadcasting/transmitting systems 20, cable television broadcasting/transmitting systems 30, satellite television broadcasting/transmitting systems 40, and content provider broadcasting/transmitting systems 50, and/or the user can respond to ratings surveys or questionnaires performed by or circulated by operators of the ratings computer(s) 60 or by any of the operators of any of the herein-described television broadcasting/transmitting systems 20, cable television broadcasting/transmitting systems 30, satellite television broadcasting/transmitting systems 40, and content provider broadcasting/transmitting systems 50. Any user responses to any surveys or questionnaires can be stored in the central processing computer 10, the ratings computer(s) 60, the marketing services computer(s) 70, and/or any of the television broadcasting/transmitting systems 20, cable television broadcasting/transmitting systems 30, satellite television broadcasting/transmitting systems 40, and content provider broadcasting/transmitting systems 50.

In another preferred embodiment, the user can, at step 505, access marketing information, advertisements, commercials, and/or any other marketing materials, for any of the entertainment content provided by any of the television broadcasting/transmitting systems 20, cable television broadcasting/transmitting systems 30, satellite television broadcasting/transmitting systems 40, and/or content provider broadcasting/transmitting systems 50, described herein, and/or for any goods, products, and/or services, by either requesting same from the central processing computer 10 and/or by accessing and requesting same from the marketing services computer(s) 70. In another preferred embodiment, a user can, at step 505, also request to receive marketing materials, marketing information, advertisements, commercials, regarding any of the herein-described entertainment content provided by any of the herein-described television broadcasting/transmitting systems 20, cable television broadcasting/transmitting systems 30, satellite television broadcasting/transmitting systems 40, and content provider broadcasting/transmitting systems 50, and/or for any goods, products, and/or services, by either requesting same from the central processing computer 10 and/or by accessing and requesting same from the marketing services computer(s) 70.

In another preferred embodiment, a user can, at step 505, also request to receive certain marketing materials, marketing information, advertisements, commercials, regarding any of the herein-described entertainment content provided by any of the herein-described television broadcasting/transmitting systems 20, cable television broadcasting/transmitting systems 30, satellite television broadcasting/transmitting systems 40, and content provider broadcasting/transmitting systems 50, and/or for any goods, products, and/or services, provided along with or in the entertainment content he or she is provided with pursuant to his or her personal entertainment account.

For example, if a user is in the market to purchase a new car, he or she can request to receive commercials or advertisements for new cars as commercials in his or her entertainment content. The request can be transmitted to and stored in the central processing computer 10 and any of the herein-described marketing services computers 70. Thereafter, at least some of the commercials viewed by the user can include commercials or advertisements for new cars. The above request can be made for commercials and/or advertisements or other marketing information for any good, product, or service, as well as for any of the herein-described entertainment content described herein. In this manner, with personal entertainment accounts associated with a single individual, the apparatus 100 an be an effective marketing tool as marketers can engage in more effective targeted marketing campaigns directly with users.

In another preferred embodiment, a user can, at step 505, also participate in and/or respond to marketing surveys or questionnaires performed by or circulated by operators of the marketing services computer(s) 70 or by any of the operators of any of the herein-described television broadcasting/transmitting systems 20, cable television broadcasting/transmitting systems 30, satellite television broadcasting/transmitting systems 40, and content provider broadcasting/transmitting systems 50. Any user responses to any surveys or questionnaires can be stored in the central processing computer 10, the ratings computer(s) 60, the marketing services computer(s) 70, and/or any of the television broadcasting/transmitting systems 20, cable television broadcasting/transmitting systems 30, satellite television broadcasting/transmitting systems 40, and content provider broadcasting/transmitting systems 50.

In another preferred embodiment, a user can, at step 505, also access any one or more of the social networking computers 80 described herein. In this regard, the user can utilize the apparatus 100 of the present invention to in order to engage in social networking activities. Operators of each of the ratings computer(s) 60, the marketing services computer(s) 70, and/or any of the herein-described television broadcasting/transmitting systems 20, cable television broadcasting/transmitting systems 30, satellite television broadcasting/transmitting systems 40, and content provider broadcasting/transmitting systems 50, can also use social networks associated with or serviced by the social networking computers 80, and any other social networking activities to perform marketing research activities, new product or content development, ratings research, conduct surveys, focus groups, circulate questionnaires, and/or perform any other activities in connection with social networks or their members or subscribers.

In another preferred embodiment, a user can, at step 505, engage in electronic commerce transactions in order to purchase goods, products, and/or services, and/or an entertainment content such as movies, shows, songs, and/or any other media content or entertainment content. Purchases can be made via any of the herein-described marketing materials, marketing information, advertisements, commercials, or any other marketing information provided by or accessible from the apparatus 100 of the present invention.

In another preferred embodiment, the apparatus 100 of the present invention can be utilized to effectuate product or services placement advertising where goods, products, or services can be place in any of the herein-described entertainment content. In a preferred embodiment, any producer, transmitter, or broadcaster, of any entertainment content, wherein products or services placement is desired to be used, can provide notice of same along with information regarding price information regarding a good, product, or services and a link or hyperlink to a web site of a seller of same, in an e-mail message to the user's registered e-mail account, and/or notice of same along with information regarding price information regarding a good, product, or services and a link or hyperlink to a website of a seller of same can also be placed in a commercial, advertisement, or marketing information, which can be broadcast as a commercial in or associated with the entertainment content. At any time, the user can utilize the link or hyperlink to access the sell's website and purchase the good, product, or services.

In another preferred embodiment, the apparatus 100 of the present invention can be utilized in order to allow a user to record entertainment content either when he or she is unable to view or listen to an airing of same, or for later and/or repeat viewing or listening. In a preferred embodiment, the user can access the central processing computer 10 using a personal communication device 90 and can transmit a request or an instruction that the central processing computer 10 record the entertainment content with the digital video/audio recording system 10J. Once the entertainment content has been recorded, it can be stored at the central processing computer 10 can be retrieved by the user at any time for viewing or listening via the personal communication device and the television 95 or via the personal communication device. In this manner, the entertainment content can be recorded, stored, and accessed, at and via the central processing computer 10, thereby providing remote recording or storage of the entertainment content by the central processing computer 10 and/or, if a cloud computer network or a cloud computing environment is utilized, then providing remote recording or storage of the entertainment content by the cloud associated with the central processing computer 10 and/or the apparatus 100. In another preferred embodiment, the user can program the personal communication device 10 to record and store the entertainment content for later retrieval and viewing and/or listening by the user via the personal communication device 90 ad/or by the personal communication device 90 and an entertainment device 95.

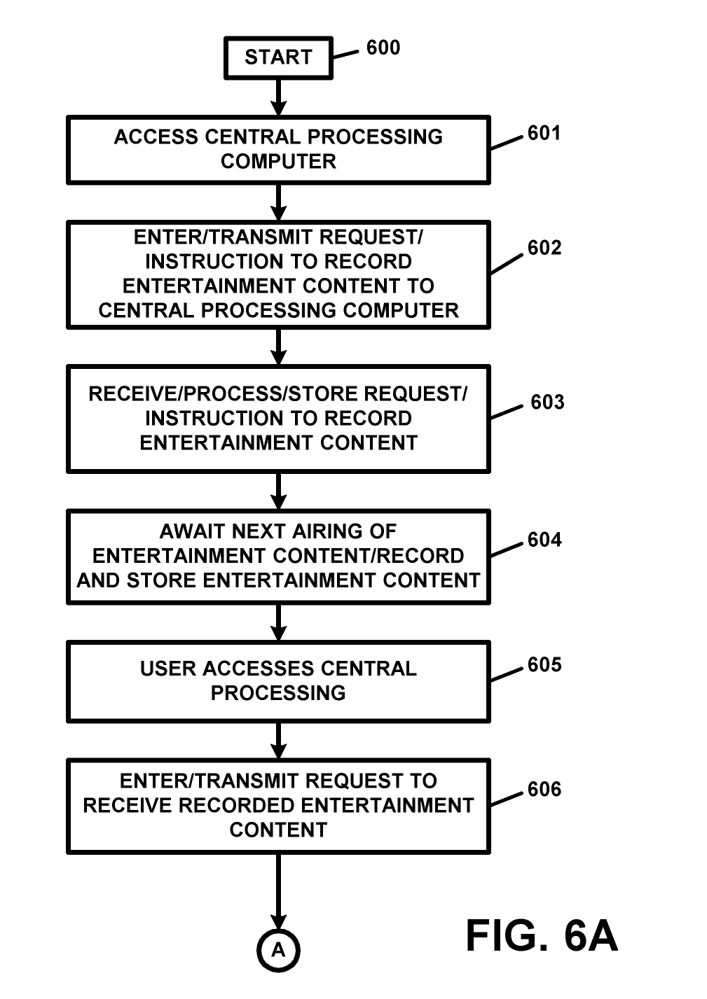

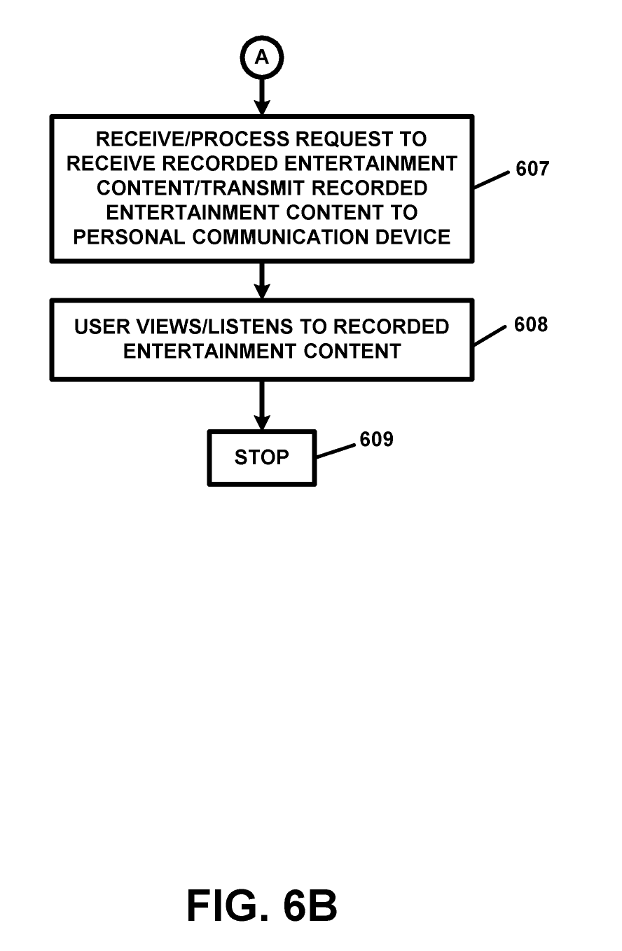

FIGS. 6A and 6B illustrate a preferred embodiment method of utilizing the apparatus 100 and method of the present invention, in flow diagram from. With reference to FIGS. 6A and 6B, the operation of the apparatus 100 commences at step 600. At step 601, the user can access the central processing computer 10 using a personal communication device 90. At step 602, the user can enter into the personal communication device 90, and can transmit to the central processing computer 10, a request or an instruction that the central processing computer 10 record the entertainment content of interest to the user. In a preferred embodiment, the request or instruction can include the name or the entertainment content, the channel or television channel is to be aired over and the time of airing. In another preferred embodiment, the central processing computer 10 can, after receiving the request or instruction, search through any programming schedules and identify the next airing of the entertainment content.

At step 603, the central processing computer 10 can receive, process, and/or store, any information regarding the request or instruction to record the entertainment content. At step 604, the central processing computer 10 can await the next airing of the entertainment content. Upon detecting the next airing of the entertainment content, the central processing computer 10 will record and store same with and/or using the digital video/audio recording system 10J. In another preferred embodiment, the user can request or instruct the central processing computer 10 to record and the entertainment content on a regular or repeated basis, such as when the user may desire to record a daily or weekly program or show on a repeat basis. Thereafter, the central processing computer 10 can await the user's accessing of the central processing computer 10 in order to retrieve the recording of the entertainment content with or via the personal communication device 90.

At step 605, the user can access the central processing computer 10 via the personal communication device 90. At step 606, the user can enter into the personal communication device 90, and transmit to the central processing computer 10, a request to be provided with the recorded entertainment content. At step 607, the central processing computer 10 can receive and process the user's request to be provided with the recorded entertainment content and will transmit the recorded entertainment content to the personal communication device 90. At step 608, the user can then view and/or listen to the recorded entertainment content via the personal communication device 90 and the television 95 or entertainment device 95. If no entertainment device 95 or television 95 is utilized, then, at step 608, the user can view and/or listen to the recorded entertainment content via the personal communication device 90. After the transmission or the broadcast of the recorded entertainment content has been completed or has been otherwise terminated, the operation of the apparatus 100 will cease at step 609.

In another preferred embodiment, the user can request or instruct the central processing computer 10 to record and store the entertainment content on a regular or repeated basis, such as when the user may desire to record a daily, weekly, or otherwise programmed or broadcast, program or show, or any other entertainment content, on a repeat and/or regular basis. In another preferred embodiment, the user can request or instruct the central processing computer 10 to record any number of shows, programs, or any other entertainment content or instances or entertainment content.

In another preferred embodiment, the user can select the length of time the recorded entertainment content is to be stored at or in the central processing computer 10 and can so program the central processing computer 10 via the personal communication device 90. In another preferred embodiment, the user can program the personal communication device 90 to record and store the entertainment content, which the user wants to record, with or using the entertainment equipment system 90K of the personal communication device 90. The user can, thereafter, view or listen to the recorded entertainment content via the personal communication device 90 and the entertainment device 95 or the television 95.

In another preferred embodiment, the apparatus 100 of the present invention can be utilized in order to provide an individual, user, member, or subscriber, with entertainment content via his or her personal entertainment account while traveling and/or away from home. The apparatus 100 of the present invention can be utilized to provide entertainment content which is being broadcast at its regular time(s) and/or can record entertainment content for the user and provide the recorder entertainment content to the user at any time the user desires to view or listen to same and/or on demand.

In a preferred embodiment, the apparatus of the present invention 100 can provide the user with entertainment content regardless of the time zone difference between the user's home time zone, or registered time zone, and the time zone in which the user may be located while travelling and/or otherwise away from home.

In a preferred embodiment, the apparatus 100 of the present invention can provide the user with and/or of the entertainment content which is available via the user's personal entertainment account, and/or can record and store, for the user's later retrieval, any entertainment content available via the user's personal entertainment account. In a preferred embodiment, the apparatus 100 and/or the central processing computer 10 can be programmed to determine or ascertain the time zone in which the user's personal communication device 90 is located, and search for and identify entertainment content, including, but not limited to, any channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, which is available for viewing or listening in that geographical location, region, entertainment or media market, or time zone, which may be of interest to the user (hereinafter referred to as “roaming entertainment content”).

In another preferred embodiment, the personal communication device 90 can be programmed to determine or ascertain the time zone in which the user's personal communication device 90 is located, and search for and identify entertainment content, including, but not limited to, any channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, which is available for viewing or listening in that geographical location, region, entertainment or media market, or time zone, which may be of interest to the user. In another preferred embodiment, the personal communication device 90 can be programmed to automatically transmit a signal to the central processing computer 10 requesting that the central processing computer 10 determine or ascertain the time zone in which the user's personal communication device 90 is located, and search for and identify the roaming entertainment content which may be of interest to the user.

In a preferred embodiment, any roaming entertainment content can be identified and selected by the central processing computer 10 upon the central processing computer 10 ascertaining the user's location or time zone. In a preferred embodiment, the personal communication device 90 can transmit position or location information obtained via the global positioning device 90J of the personal communication device 90. In a preferred embodiment, the personal communication device 90 can be programmed to transmit position or location information anytime the user accesses the central processing computer 10 in order to utilize the present invention and/or to access his or her personal entertainment account. In another preferred embodiment, the user can, while traveling, away from home, or otherwise roaming, activate the global positioning device 90J to determine the user's position or location and/or time zone and, thereafter, the personal communication device 90 can automatically transmit the position, location, and/or time zone information to the central processing computer 10. In another preferred embodiment, the central processing computer 10 can automatically transmit a signal to the personal communication device 90 instructing or requesting that the position or location information and/or time zone information be transmitted from the personal communication device 90 to the central processing computer 10. In another preferred embodiment, the central processing computer 10 can also ascertain the position or location of the personal communication device 90 by “pinging” same.

In a preferred embodiment, a user, at any time, can also access the central processing computer 10 via the personal communication device 90 and can request that certain entertainment content be recorded and stored by the central processing computer 10, while the user is away from home or travelling, for later retrieval by the user. In another preferred embodiment, the user can also program his or her personal communication device 90 to record and store certain entertainment content while the user is away from home or travelling, for later retrieval by the user. In another preferred embodiment, the user can also program the central program the central processing computer 10 to search for and identify roaming entertainment content for the user for any and/or each geographical location, region, entertainment or media market, or time zone, in which the user is located or in or to which the user plans to travel. The user, in a preferred embodiment, can pre-program the central processing computer 10 or the personal communication device 90 to identify and/or located any type or kind of roaming entertainment content for the user.

In a preferred embodiment, the apparatus 100 of the present invention can be utilized in order to provide an individual, user, member, or subscriber, with any entertainment content available via his or her personal entertainment account, with any entertainment content available via his or her personal entertainment account which is to be, or has been, recorded for the user for his or her later retrieval, and/or any roaming entertainment content which has been identified for the user in any geographical location, region, entertainment or media market, or time zone, in which the user is located or in or to which the user plans to travel. In a preferred embodiment, the user can pre-program the central processing computer 10 and/or the personal communication device 90 in order to request that entertainment content be recorded and/or that roaming entertainment content be identified.

In another preferred embodiment, the central processing computer 10 can also be programmed to search for and/or identify any commercials, advertisement, or marketing materials, or any coupons, discount coupons, or any other incentives to purchase, any goods, products, or services, identified as being offered in the geographical location, region, entertainment or media market, or time zone, in which the user is located or in or to which the user plans to travel.

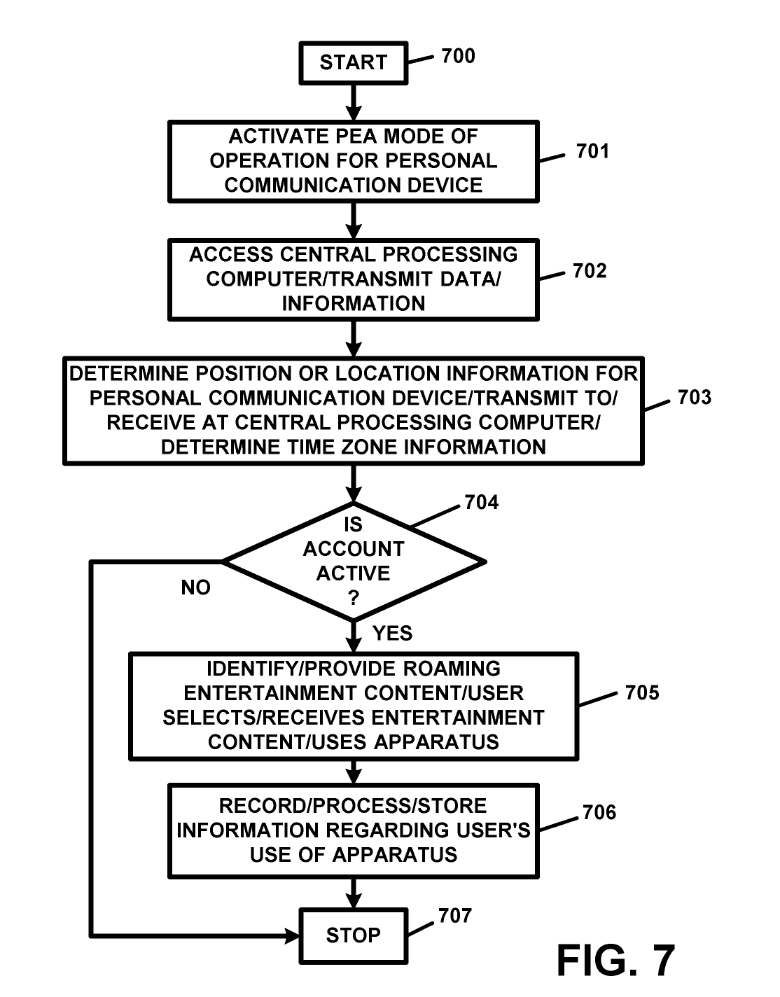

FIG. 7 illustrates a preferred embodiment method for utilizing the apparatus 100 and method of the present invention, in flow diagram form. Prior to using the embodiment of FIG. 7, the user can access the central processing computer 10 via the personal communication device and request that certain entertainment content be recorded and stored by the central processing computer 10 as described herein in the preferred embodiment of FIGS. 6A and 6B. In a preferred embodiment, the user can request that any number of the channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, available via his or her personal entertainment account, be recorded and stored for later retrieval, by the central processing computer 10 and, in particular, by the digital video/audio recording system 10J of the central processing computer 10.

In another preferred embodiment, the user can also program his or her personal communication device 90 to record and store, for later retrieval, any number of the channel(s), television channel(s), programming channel(s), shows, movies, programs, news programs or shows, television programs or shows, radio programs or shows, informational programs or shows, entertainment programs or shows, sporting and/or athletic programs or shows, educational programs or courses, advertisements, commercials, and/or marketing information, available via his or her personal entertainment account.

Prior to using the embodiment of FIG. 7, the user can also request, activate, or program, the central processing computer to search for and/or identify any roaming entertainment content for the user. In another preferred embodiment, the user can also request, activate, or program, the personal communication device 10 to search for and/or identify any roaming entertainment content for the user.

Prior to using the preferred embodiment of FIG. 7, if same is to be used in connection with an entertainment device 95 or a television 95, such as, for example, any television or entertainment device which is available for use by the user, the personal communication device 90 will have to be connected to or with, or linked to or with, the television 95 or the entertainment device 95 as described herein so that the pertinent entertainment content output or output device of the personal communication device 90 is connected to, or linked with, the pertinent input or input device of the television 95.

With reference to FIG. 7, the operation of the apparatus 100 commences at step 700. At step 701, the user activates the “personal entertainment account” mode of operation or operating mode of the personal communication device 90. In a preferred embodiment, the activation of the “personal entertainment account” mode of operation or operating mode, of the personal communication device 90, starts the operation of the personal communication device 90 in this “personal entertainment account” mode of operation. In a preferred embodiment, the “personal entertainment account” mode of operation and/or the personal communication device 90 can operate or can be run, and/or can be controlled, pursuant to software, a software application(s) or a software “app”(s), which can control the operation of the personal communication device 90 in this mode of operation.

At step 702, the personal communication device 90 can access the central processing computer 10 and can transmit data and/or information regarding the personal entertainment account associated with the user and/or with the personal communication device 90 to the central processing computer 10. The data and/or information can include, but need not be limited to, a personal entertainment account number and/or any other identifying information. At step 702, the central processing computer 10 will receive the data and/or information transmitted from the personal communication device 90.

At step 703, the global positioning device 90J of the personal communication device 90 can calculate, determine, or ascertain the position or location of the personal communication device 90 and also transmit the position or location information to the central processing computer 10. At step 703, if position or location information previously transmitted to, or calculated, determined, or ascertained, by the central processing computer 10, the central processing computer 10 will retrieve same. At step 703, the central processing computer 10 can also calculate, determine, or ascertain, the position or location of the personal communication device 90 such as by requesting same, by transmitting a signal to the personal communication device 90 or by “pinging” the personal communication device 90.

At step 703, the central processing computer 10 will receive and process the data and/or information regarding the personal entertainment account, and/or any of the data and/or information and/or any position or location information transmitted from the personal communication device 90 at step 703. At step 703, the central processing computer 10 can also determine the time zone in which the personal communication device 90 is located as well as determine the home time zone associated with the personal communication account.

At step 704, the central processing computer 10 can also determine if the personal entertainment account is active or in good standing so that it can be used. If at step 704, the central processing computer 10 determines that the personal entertainment account is inactive or is not in good standing, then the central processing computer 10 can terminate the operation of the apparatus 10 at step 707. If at step 704, the central processing computer 10 determines that the personal entertainment account is active or in good standing, so that it can be used, then the operation of the apparatus 100 will proceed to step 705.

At step 705, the central processing computer 10 can identify the roaming entertainment content, for the geographical location, region, entertainment or media market, or time zone, in which the user is located, and can transmit data and/or information regarding the roaming entertainment content which is available to the user to the personal communication device 90. At step 705, the user can then select any television channel in his or her personal entertainment account and/or in the roaming entertainment content for viewing or listening, or for receiving, on or via the television 95. In a preferred embodiment, any and/or all entertainment content provided by each of the herein-described television broadcasting/transmitting systems 20, cable television broadcasting/transmitting systems 30, satellite television broadcasting/transmitting systems 40, and content provider broadcasting/transmitting systems 50, can be continuously transmitted to or broadcast to the central processing computer 10 so that the central processing computer 10 can transmit or broadcast any and/or all entertainment content associated with or included in the user's personal entertainment account and/or in the roaming entertainment content to the personal communication device 90.

At step 705, the user's television channel selection can be transmitted to the central processing computer 10. In response to receiving the user's television channel selection, the central processing computer 10 will transmit or broadcast the entertainment content being provided on that television channel to the personal communication device 90 and the entertainment content will be provided to the user via the television 95.

In another preferred embodiment or in an alternate preferred embodiment, at step 705, any and/or all entertainment content provided by each of the herein-described television broadcasting/transmitting systems 20, cable television broadcasting/transmitting systems 30, satellite television broadcasting/transmitting systems 40, and content provider broadcasting/transmitting systems 50, can be continuously transmitted to or broadcast to the central processing computer 10 and the central processing computer 10 can, in turn, continuously transmit or broadcast any and/or all of the entertainment content associated with or included in all of the channels included in the user's personal entertainment account to the personal communication device 90. In this regard, in another preferred embodiment or in an alternate embodiment, the entertainment content being provided on the user selected television channel will be provided to the user via the television 95 without having to transmit any television channel selection to the central processing computer 10. In such an alternate preferred embodiment, all channels in the user's personal entertainment account and/or in the roaming entertainment content are and/or will be available for selection at the personal communication device 90, thereby dispensing with any need to transmit any television channel selection to the central processing computer 10.

At step 705, the user can also select to retrieve any recorded and/or stored entertainment content which he or she had previously requested to be recorded. For example, if the user has a favorite daily news program or a television show or program that he or she watches while at home and he or she desires to watch same while traveling in a different time zone, he or she can request that the central processing computer 10 record and store same for his or her later retrieval and viewing. At step 705, the user can also enter request or instruct the central processing computer 10 to record and store any other entertainment content whether it is available in his or her personal entertainment account or available in the roaming entertainment content.

At step 705, the user can watch whichever channels he or she desires, can change channels, view commercials or advertisements, and/or utilize his or her personal entertainment account and/or the roaming entertainment content in any desired manner. When the user is finished using his or her personal entertainment account he or she can simply de-activate or exit the “personal entertainment account” mode of operation of the personal communication device 10 at step 706. At step 706, the central processing computer 10 can record, process, and/or store, any information regarding the user's use of the personal entertainment account and/or any use of any of the roaming entertainment content. Thereafter, the operation of the apparatus 100 will cease at step 707.

In another preferred embodiment of the embodiment of FIG. 7, the apparatus 100 of the present invention can be utilized without the television 95 or entertainment device 95. In this preferred embodiment, any and/or all entertainment content can be provided to the user via the personal communication device 90.

In another preferred embodiment, the user, at step 705, can make changes to his or her personal entertainment account, add any of the herein-described entertainment content or channels to his or her personal entertainment account, delete any of the of the herein-described entertainment content or channels from his or her personal entertainment account, and/or make any other changes, set or establish criteria for receiving alerts or alert messages, place limitations or restrictions on the use of his or her personal entertainment account, and/or perform any other activity regarding same. At step 705 and/or at step 706, the central processing computer 10 can receive, process, and/or store, any information regarding any changes made by the user.

In another preferred embodiment, the user can, at step 705, access ratings information by ether requesting same from the central processing computer 10 and/or by accessing and requesting same from the ratings computer(s) 60. In another preferred embodiment, a user can, at step 705, also request to receive ratings reports regarding any of the herein-described entertainment content and/or roaming entertainment content provided by any of the herein-described television broadcasting/transmitting systems 20, cable television broadcasting/transmitting systems 30, satellite television broadcasting/transmitting systems 40, and content provider broadcasting/transmitting systems 50, and/or the user can respond to ratings surveys or questionnaires performed by or circulated by operators of the ratings computer(s) 60 or by any of the operators of any of the herein-described television broadcasting/transmitting systems 20, cable television broadcasting/transmitting systems 30, satellite television broadcasting/transmitting systems 40, and content provider broadcasting/transmitting systems 50. Any user responses to any surveys or questionnaires can be stored in the central processing computer 10, the ratings computer(s) 60, the marketing services computer(s) 70, and/or any of the television broadcasting/transmitting systems 20, cable television broadcasting/transmitting systems 30, satellite television broadcasting/transmitting systems 40, and content provider broadcasting/transmitting systems 50.

In another preferred embodiment, the user can, at step 705, access marketing information, advertisements, commercials, and/or any other marketing materials, for any of the entertainment content, and/or roaming entertainment content, provided by any of the television broadcasting/transmitting systems 20, cable television broadcasting/transmitting systems 30, satellite television broadcasting/transmitting systems 40, and/or content provider broadcasting/transmitting systems 50, described herein, and/or for any goods, products, and/or services, by either requesting same from the central processing computer 10 and/or by accessing and requesting same from the marketing services computer(s) 70. In another preferred embodiment, a user can, at step 705, also request to receive marketing materials, marketing information, advertisements, commercials, regarding any of the herein-described entertainment content and/or roaming entertainment content provided by any of the herein-described television broadcasting/transmitting systems 20, cable television broadcasting/transmitting systems 30, satellite television broadcasting/transmitting systems 40, and content provider broadcasting/transmitting systems 50, and/or for any goods, products, and/or services, by either requesting same from the central processing computer 10 and/or by accessing and requesting same from the marketing services computer(s) 70.

In another preferred embodiment, a user can, at step 705, also request to receive certain marketing materials, marketing information, advertisements, commercials, regarding any of the herein-described entertainment content and/or roaming entertainment content provided by any of the herein-described television broadcasting/transmitting systems 20, cable television broadcasting/transmitting systems 30, satellite television broadcasting/transmitting systems 40, and content provider broadcasting/transmitting systems 50, and/or for any goods, products, and/or services, provided along with or in the entertainment content he or she is provided with pursuant to his or her personal entertainment account.

In another preferred embodiment, a user can, at step 705, also participate in and/or respond to marketing surveys or questionnaires performed by or circulated by operators of the marketing services computer(s) 70 or by any of the operators of any of the herein-described television broadcasting/transmitting systems 20, cable television broadcasting/transmitting systems 30, satellite television broadcasting/transmitting systems 40, and content provider broadcasting/transmitting systems 50. Any user responses to any surveys or questionnaires can be stored in the central processing computer 10, the ratings computer(s) 60, the marketing services computer(s) 70, and/or any of the television broadcasting/transmitting systems 20, cable television broadcasting/transmitting systems 30, satellite television broadcasting/transmitting systems 40, and content provider broadcasting/transmitting systems 50.

In another preferred embodiment, a user can, at step 705, also access any one or more of the social networking computers 80 described herein. In this regard, the user can utilize the apparatus 100 of the present invention to in order to engage in social networking activities. Operators of each of the ratings computer(s) 60, the marketing services computer(s) 70, and/or any of the herein-described television broadcasting/transmitting systems 20, cable television broadcasting/transmitting systems 30, satellite television broadcasting/transmitting systems 40, and content provider broadcasting/transmitting systems 50, can also use social networks associated with or serviced by the social networking computers 80, and any other social networking activities to perform marketing research activities, new product or content development, ratings research, conduct surveys, focus groups, circulate questionnaires, and/or perform any other activities in connection with social networks or their members or subscribers.

In another preferred embodiment, a user can, at step 705, engage in electronic commerce transactions in order to purchase goods, products, and/or services, and/or any entertainment content such as movies, shows, songs, and/or any other media content or entertainment content. Purchases can be made via any of the herein-described marketing materials, marketing information, advertisements, commercials, or any other marketing information provided by or accessible from the apparatus 100 of the present invention.

In any and/or all of the embodiments described herein, the central processing computer 10, as well as any of the television broadcasting/transmitting systems 20, cable television broadcasting/transmitting systems 30, satellite television broadcasting/transmitting systems 40, content provider broadcasting/transmitting systems 50, the ratings computer(s) 60, the marketing services computer(s) 70, and/or the social networking computer(s) 80, can generate alerts, alert messages, notification messages, and/or any other type or kind of messages (hereafter referred to as “alerts”), which can be transmitted to a user's personal communication device. In a preferred embodiment, the alerts, alert messages, notification messages, and/or any other type or kind of messages, can be transmitted to the user's personal communication device 90 in or as an e-mail message, an instant messaging message, a recorded telephone message, a recorded voicemail message, or any other suitable message. In a preferred embodiment, the user can, at any time and by transmitting a request or instruction to the central processing computer 10, request to be provided with certain alerts. In a preferred embodiment, certain other alerts can also be automatically provided to the user.

In a preferred embodiment, the types or kinds of alerts can vary depending upon the situation and the respective computer or system which is generating and transmitting same. In a preferred embodiment, for example, the central processing computer 10 can generate and transmit an alert to the user's personal communication device 10 to alert or notify the user that his or her personal entertainment account has been created or established, that the personal entertainment account has been accessed or utilized, that the personal entertainment account has been used in a manner deviating from the user's normal use of same, that the personal entertainment account have been used for a certain amount of time or that a time of usage or a cumulative time of usage in pre-specified time period is about to be reached, has been reached, or has been exceeded, that changes to entertainment content has occurred such as, for example, but not limited to, certain entertainment content being cancelled or discontinued or certain entertainment content becoming available, that content involving a certain actor, actress, performer, singer, musician, celebrity, or personality, or other individual, has become available or will be discontinued, that financial transactions or financial-related occurrences have occurred or are occurring on the account, such as, for example, that bills for personal entertainment accounts are available, are due, have been paid, or are overdue, that financial transactions such as payments, charges, credits, and/or purchases or goods, products, or services, and/or entertainment content, has occurred or are occurring on the personal entertainment account, that an attempt has been made or access and/or to use a personal entertainment account at an unauthorized time or for an unauthorized reason or purpose, that an attempt has been made to access unauthorized or disallowed entertainment content, that an attempt has been made or is being made to use the personal entertainment account and/or to use same in an unauthorized manner, and/or that an event, occurrence, or happening, has taken place with, on, or involving, the personal entertainment account, and/or an alert for any other reason or purpose wherein a notification to the user of the personal entertainment account may be warranted or of interest to the user.

In a preferred embodiment, any of the central processing computer(s) 10, the television broadcasting/transmitting systems 20, cable television broadcasting/transmitting systems 30, satellite television broadcasting/transmitting systems 40, content provider broadcasting/transmitting systems 50, the ratings computer(s) 60, the marketing services computer(s) 70, and/or the social networking computer(s) 80, can also generate and/or send an alert to the user's personal communication device 90 upon the occurrence in changes in entertainment content, changes in programming schedules, the availability of certain entertainment content, and/or the cancellation of certain entertainment content, and/or the availability of ratings information, ratings surveys, ratings questionnaires, and/or other ratings information, and/or ratings-related activities and/or programs in which users can participate in for compensation or for no compensation, and/or the availability of commercials, advertisements, marketing material or marketing information, marketing surveys, marketing questionnaires, marketing research activities, focus groups, trials, on-line focus groups, and/or marketing-related activities and/or programs in which users can participate in for compensation or for no compensation, and/or other marketing information, and/or information regarding a user's social network(s), such as but not limited to, social networking activities and/or events, social networking friends and/or followers, additions of new members to a social network, the exiting of members from a social network, and/or any other social network which a user can or may join, and/or any other event, occurrence, or happening, the occurrence of which may be or interest to the user.

In a preferred embodiment, any and/or all of the alerts described herein as being provided by the apparatus 100 of the present invention can be transmitted by the central processing computer 10 and/or by the respective television broadcasting/transmitting system 20, cable television broadcasting/transmitting system 30, satellite television broadcasting/transmitting system 40, content provider broadcasting/transmitting system 50, ratings computer 60, marketing services computer 70, or social networking computer 80, which generated the respective alert.

In a preferred embodiment, any of the herein-described alerts can be generated by and/or transmitted from any of the herein-described central processing computer(s) 10, the television broadcasting/transmitting systems 20, cable television broadcasting/transmitting systems 30, satellite television broadcasting/transmitting systems 40, content provider broadcasting/transmitting systems 50, the ratings computer(s) 60, the marketing services computer(s) 70, and/or the social networking computer(s) 80, at any time and independently, and without interfering with any of the normal operation and/or processing activities of same.

In any and/or all of the embodiments described herein, the central processing computer 10, in processing any data and/or information regarding any activity, operation, or transaction, on, involving, or regarding, any of the herein-described personal entertainment accounts, or in processing any requests, instructions, actions, operations, or transactions, and/or any data and/or information regarding same, made by, received from, performed by, entered by, or transmitted from any personal communication device(s) 90 associated with any personal entertainment account(s) of or associated with, any of the herein-described individuals, users, members, or subscribers, can process any information regarding any of the above activities, operations, transactions, requests, or instructions, using, or in conjunction with, any of the herein-described limitations or restrictions, which may be placed on or involving the personal entertainment account, in order to allow authorized use of, or activity on or involving, a personal entertainment account and/or in order to disallow, prevent, or prohibit, unauthorized use of, or unauthorized activity on or involving, a personal entertainment account.

In any and/or all of the embodiments described herein, the apparatus 100 and the methods of the present invention is utilized via, on, or over, the Internet and/or the World Wide Web. In this regard, any and/or all data, information, messages, and/or entertainment content described herein is transmitted via, on, or over, the Internet and/or the World Wide Web. Although the Internet and/or the World Wide Web is a preferred system, network, and/or medium, utilized, the present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

The apparatus 100 of the present invention can also administer financial accounts, and/or can process financial transactions, and/or effectuate payments, for, on behalf of, or involving, any of the individual, users, members, or subscribers, who have personal entertainment accounts and/or who otherwise utilize the present invention, as well as administer financial accounts, and/or can process financial transactions, and/or effectuate payments, for, on behalf or, of involving, any of the companies, entities, or individuals, who either own, manage, or operate, any of the herein-described central processing computers 10, the television broadcasting/transmitting systems 20, the cable television broadcasting/transmitting systems 30, the satellite television broadcasting/transmitting systems 40, the content provider broadcasting/transmitting systems 50, the ratings computers 60, the marketing services computers 70, and/or the social networking computers 80, described herein.

The present invention provides an apparatus 100 and methods for using same which provides a user with a personal entertainment account which can be customizable by the user and which can be utilized by the user while at home or away from home in order to access entertainment content utilizing any suitable personal communication device.

The present invention provides an apparatus 100 and methods which can allow a user to watch or listen to his or her home or local entertainment content or programming, such as, but not limited to, home or local television stations or radio stations, from anywhere in the World where he or she an access a suitable communication network or system, and/or which can allow the user to record entertainment content for later retrieval while at home, away from home, or when located in a time zone different from his or her home time zone. The apparatus 100 and methods of the present invention also allows a user to customize his or her own personal entertainment account and also allows the user make changes to same, add entertainment content, and/or delete entertainment content at any time, in real-time, and/or “on the fly”.

The present invention also provides an apparatus 100 which can all a user to utilize any of the herein-described personal communication devices 90 as a personal set-top box, a personal cable television box, a personal satellite television box, a personal gaming device or box, gaming console, or any other personal entertainment center, device, or hub, which can be portable and/or mobile. For example, a cellular telephone, a smart phone, a personal digital assistant, a tablet, or a tablet computer or a laptop computer, can be utilized as, and/or can serve as, a personal set-top box, a personal cable television box, a personal satellite television box, a personal gaming device or box, gaming console, or any other personal entertainment center, device, or hub, in order to allow a user to access and utilize his or her personal entertainment account.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. An apparatus for providing entertainment content, comprising:
a personal communication device, wherein the personal communication device is associated with a user, and further wherein the personal communication device is a laptop computer, a notebook computer, a tablet computer, a cellular telephone, a personal digital assistant, a wireless telephone, or a smart phone, and further wherein the personal communication device receives entertainment content provided pursuant to a personal entertainment account of the user, wherein the personal entertainment account is administered by a central processing computer and includes information regarding entertainment content provided by a plurality of content providers, and further wherein the personal entertainment account includes information regarding user pre-selected entertainment content, wherein the personal communication device transmits a request to receive entertainment content from among the user pre-selected entertainment content and roaming entertainment content which is automatically identified by the central processing computer based upon a location or position of the personal communication device or based upon a time zone within which the personal communication device is located, wherein the entertainment content requested is transmitted to the personal communication device via, on, or over, the Internet or the World Wide Web; and
an entertainment device or a television, wherein the personal communication device is connected to or linked with the entertainment device or the television via a Wi-Fi connection or Wi-Fi equipment, via a Bluetooth connection or Bluetooth equipment, or via a wired connection, and further wherein the personal communication device transmits the entertainment content requested to the entertainment device or to the television via the Wi-Fi connection or Wi-Fi equipment, via the Bluetooth connection or Bluetooth equipment, or via the wired connection, and further wherein the entertainment device or the television provides, plays, or displays, the entertainment content requested,
wherein the personal communication device or the apparatus is specially programmed to receive and provide to the entertainment device or to the television the entertainment content requested, and further wherein information regarding the use of the personal entertainment account or the use of the roaming entertainment content is stored in the central processing computer.

2. The apparatus of claim 1, wherein the information regarding a restriction or a limitation on the use of the personal entertainment account is transmitted from the personal communication device to the central processing computer and stored in the central processing computer.

3. The apparatus of claim 1, wherein information regarding a request to receive a notification message or an alert message is transmitted from the personal communication device to the central processing computer and stored in the central processing computer.

4. The apparatus of claim 1, wherein the entertainment content requested is a television program.

5. An apparatus for providing entertainment content, comprising:
a central processing computer, wherein the central processing computer is specially configured to distribute entertainment content which is provided by a plurality of content providers, and further wherein the central processing computer is specially configured to store information regarding a personal entertainment account for each of a plurality of users;
a personal communication device, wherein the personal communication device is associated with a user of the plurality of users, and further wherein the personal communication device is a laptop computer, a notebook computer, a tablet computer, a cellular telephone, a personal digital assistant, a wireless telephone, or a smart phone, and further wherein the personal communication device receives entertainment content provided pursuant to a personal entertainment account of the user, wherein the personal entertainment account includes information regarding entertainment content provided by a plurality of content providers, and further wherein the personal entertainment account includes information regarding user pre-selected entertainment content, wherein the personal communication device transmits a request to receive entertainment content from among the user pre-selected entertainment content and roaming entertainment content which is automatically identified by the central processing computer based upon a location or position of the personal communication device or based upon a time zone within which the personal communication device is located, wherein the entertainment content requested is transmitted to the personal communication device via, on, or over, the Internet or the World Wide Web; and
an entertainment device or a television, wherein the personal communication device is connected to or linked with the entertainment device or the television via a Wi-Fi connection or Wi-Fi equipment, via a Bluetooth connection or Bluetooth equipment, or via a wired connection, and further wherein the personal communication device transmits the entertainment content requested to the entertainment device or to the television via the Wi-Fi connection or Wi-Fi equipment, via the Bluetooth connection or Bluetooth equipment, or via the wired connection, and further wherein the entertainment device or the television provides, plays, or displays, the entertainment content requested,
wherein the personal communication device is specially programmed to receive and provide to the entertainment device or to the television the entertainment content requested, and further wherein information regarding the use of the personal entertainment account or the use of the roaming entertainment content is stored by the central processing computer.

6. The apparatus of claim 5, wherein the information regarding a restriction or a limitation on the use of the personal entertainment account is transmitted from the personal communication device to the central processing computer and stored in the central processing computer.

7. The apparatus of claim 5, wherein information regarding a request to receive a notification message or an alert message is transmitted from the personal communication device to the central processing computer and stored in the central processing computer.

8. The apparatus of claim 5, wherein the entertainment content requested is a television program.

9. An apparatus for providing entertainment content, comprising:
a personal communication device, wherein the personal communication device is associated with a user, and further wherein the personal communication device is a laptop computer, a notebook computer, a tablet computer, a cellular telephone, a personal digital assistant, a wireless telephone, or a smart phone, and further wherein the personal communication device receives entertainment content provided pursuant to a personal entertainment account of the user, wherein the personal entertainment account is administered by a central processing computer and includes information regarding entertainment content provided by a plurality of content providers, and further wherein the personal entertainment account includes information regarding user pre-selected entertainment content, wherein the personal communication device transmits a request to receive entertainment content from among the user pre-selected entertainment content and roaming entertainment content which is automatically identified by the central processing computer based upon a location or position of the personal communication device or based upon a time zone within which the personal communication device is located, wherein the entertainment content requested is transmitted to the personal communication device via, on, or over, the Internet or the World Wide Web; and
an entertainment device or a television, wherein the personal communication device is connected to or linked with the entertainment device or the television via a Wi-Fi connection or Wi-Fi equipment, via a Bluetooth connection or Bluetooth equipment, or via a wired connection, and further wherein the personal communication device transmits the entertainment content requested to the entertainment device or to the television via the Wi-Fi connection or Wi-Fi equipment, via the Bluetooth connection or Bluetooth equipment, or via the wired connection, and further wherein the entertainment device or the television provides, plays, or displays, the entertainment content requested,
wherein the personal communication device or the apparatus is specially programmed to receive and provide to the entertainment device or to the television the entertainment content requested from among the content accessible via the personal entertainment account or from among the roaming entertainment content, and further wherein information regarding the use of the personal entertainment account or the use of the roaming entertainment content is stored in the central processing computer,
and further wherein the personal communication device receives a notification message or an alert message transmitted from the central processing computer, wherein the notification message or the alert message contains information regarding a use of, or an accessing of, or a change made to, the personal entertainment account.

10. The apparatus of claim 9, wherein the information regarding a restriction or a limitation on the use of the personal entertainment account is stored by the central processing computer.
